(19) United States
(12) Patent Application Publication
(10) Pub. No.: US 2021/0168116 A1
(43) Pub. Date: Jun. 3, 2021

(54) SYSTEMS AND METHODS OF PHYSICAL INFRASTRUCTURE AND INFORMATION TECHNOLOGY INFRASTRUCTURE SECURITY

(71) Applicant: IPPSEC INC., Cambridge, MA (US)

(72) Inventors: Alexander SHULMAN, Troy, NY (US); Justin M. PELLETIER, Rochester, NY (US)

(73) Assignee: IPPSEC Inc., Cambridge, MA (US)

(21) Appl. No.: 17/044,999

(22) PCT Filed: Apr. 3, 2019
(86) PCT No.: PCT/US2019/025666

§ 371 Date: Oct. 2, 2020

Related U.S. Application Data
(60) Provisional application No. 62/652,034, filed on Apr. 3, 2018.

(51) Int. Cl. H04L 29/06; H04W 56/00; H04W 24/08; H04L 12/26; H04L 9/06; H04W 12/06; H04W 12/02; H04L 9/32

(52) U.S. Cl. CPC H04L 63/02; H04W 56/0015; H04W 24/08; H04L 43/0852; H04L 43/10; H04W 88/16; H04W 12/06; H04W 12/02; H04L 9/3242; H04L 63/08; H04L 63/0421; H04L 9/0643

(57) ABSTRACT

Systems and methods of physical infrastructure and information technology infrastructure security are provided. A data processing system can provide distributed sensing through mobile devices, active cyber defense through time-based port hopping, and message delivery verification through retinal tracking.

### CROSS-REFERENCE TO RELATED APPLICATIONS

This application claims priority under 35 U.S.C. § 119(d) to U.S. Provisional Application No. 62/652,034, filed Apr. 3, 2018, the contents of which are hereby incorporated by reference herein.

### BACKGROUND

An entity can include physical infrastructure, such as buildings, as well as information technology infrastructure, such as a networks. Events can occur in the building, such as physical events, as well as network related events, such as network hacks or attacks. It can be challenging to detect, prevent or mitigate physical or network related attacks.

### SUMMARY

This disclosure is directed to systems and methods of physical infrastructure and information technology infrastructure security. The technical solution can include systems and methods for distributed sensing through mobile devices, active cyber defense through time-based port hopping, and message delivery verification through retinal tracking.

At least one aspect is directed to a system of electronic message delivery verification. The system can include a data processing system comprising one or more processors. The data processing system can include or execute a verification component. The data processing system can detect an electronic message comprising a security flag. The electronic message may have been transmitted by a sender computing device to a recipient computing device via a network. The data processing system can receive, responsive to detection of the security flag, retinal eye movement information. A camera of the recipient computing device can track retinal eye movement of a subject during display of the electronic message to provide the retinal eye movement information. The data processing system can retrieve a retinal eye movement pattern corresponding to an account identifier associated with the recipient computing device. The data processing system can retrieve the retinal eye movement pattern from a data repository or memory. The data processing system can determine, based on a comparison of the tracked retinal eye movement with the retinal eye movement pattern, a match. The data processing system can transmit, responsive to the match, a read notification to the sender computing device.

In some embodiments, the data processing system can receive biometric information captured prior to display of the electronic message on the recipient computing device. The data processing system can authorize, based on a match between the biometric information and account information corresponding to the account identifier, the recipient computing device to display the electronic message.

The data processing system can, prior to display of the electronic message on the recipient computing device, capture initial retinal eye movement information. The data processing system can authorize, based on a match between the initial retinal eye movement information and a stored initial retinal eye movement pattern for the account identifier, the recipient computing device to display the electronic message.

The data processing system can detect a second electronic message comprising the security flag. A sender computing device can transmit the second electronic message to the recipient computing device via the network. The data processing system can receive, responsive to detection of the security flag, second retinal eye movement tracked by the camera of the recipient computing device during display of the second electronic message. The data processing system can determine, based on a comparison of the second retinal eye movement with the retinal eye movement pattern, an absence of a match. The data processing system can block, responsive to the absence of the match, transmission of a read notification for the second electronic message to the sender computing device.

The data processing system can detect a second electronic message transmitted by the sender computing device to the recipient computing device via the network. The data processing system can receive second retinal eye movement tracked by the camera of the recipient computing device during display of the second electronic message. The data processing system can determine, based on a comparison of the second retinal eye movement with the retinal eye movement pattern, an absence of a match. The data processing system can transmit, responsive to the absence of the match, an indication that the second electronic message is unread.

The data processing system can detect a second electronic message transmitted by the sender computing device to the recipient computing device via the network. The data processing system can receive second retinal eye movement tracked by the camera of the recipient computing device during display of the second electronic message. The data processing system can determine, based on a comparison of the second retinal eye movement with the retinal eye movement pattern, an absence of a match. The data processing system can transmit, responsive to the absence of the match, an indication that the second electronic message was delivered and unread.

The data processing system can detect a second electronic message transmitted by the sender computing device to the recipient computing device via the network. The data processing system can receive second retinal eye movement tracked by the camera of the recipient computing device during display of the second electronic message. The data processing system can determine, based on a comparison of the second retinal eye movement with the retinal eye movement pattern, an absence of a match. The data processing system can transmit, responsive to the absence of the match, an indication that the second electronic message was displayed on the recipient computing device and is unread.

The data processing system can receive, during display of the electronic message on the recipient computing device, second retinal eye movement subsequent to the retinal eye movement. The data processing system can terminate, based on a mismatch between the second retinal eye movement and the retinal eye movement pattern, display of the electronic message on the recipient computing device.

The data processing system can determine a duration of the match between the retinal eye movement and the retinal eye movement pattern is greater than or equal to a duration threshold. The data processing system can transmit the read notification responsive to the duration being greater than or equal to the duration threshold. The read notification can include an indication of the duration.

The data processing system can detect a second electronic message transmitted by the sender computing device to the recipient computing device via the network. The data processing system can receive second retinal eye movement tracked by the camera of the recipient computing device during display of the second electronic message. The data processing system can determine, based on a comparison of the second retinal eye movement with the retinal eye movement pattern, a match. The data processing system can determine a duration of the match between the second retinal eye movement and the retinal eye movement pattern is less than or equal to a duration threshold. The data processing system can transmit, responsive to the duration of the match less than or equal to the duration threshold, an indication that the second electronic message is unread.

At least one aspect is directed to a method of verifying electronic message delivery. A data processing system can perform the method using one or more processors. The method can include the data processing system detecting an electronic message comprising a security flag. A sender computing device can transmit the electronic message to a recipient computing device via a network. The method can include the data processing system receiving, responsive to detection of the security flag, retinal eye movement tracked by a camera of the recipient computing device during display of the electronic message. The method can include the data processing system retrieving a retinal eye movement pattern corresponding to an account identifier associated with the recipient computing device. The method can include the data processing system determining, based on a comparison of the tracked retinal eye movement with the retinal eye movement pattern, a match. The method can include the data processing system transmitting, responsive to the match, a read notification to the sender computing device.

At least one aspect is directed to a system of distributed sensing through mobile computing devices. The system can include a data processing system. The data processing system can include one or more processors. The data processing system can be in communication with a plurality of mobile devices. Each of the mobile devices can include a microphone and an infrared sensor. The data processing system can include or execute an event detection component. The data processing system can receive, from a first mobile device of the plurality of mobile devices, first location information, first acoustic information detected by a microphone of the first mobile device, and first infrared information. The data processing system can receive, from a second mobile device of the plurality of mobile devices, second location information, second acoustic information detected by a microphone of the second mobile device, and second infrared information. The data processing system can detect, based on a comparison of the first acoustic information with a threshold, a first decibel spike in the first acoustic information corresponding to an event. The data processing system can detect, based on a comparison of the second acoustic information with the threshold, a second decibel spike in the second acoustic information corresponding to the event. The data processing system can identify, responsive to detection of the first decibel spike and the second decibel spike, a variance between the first decibel spike and the second decibel spike. The data processing system can determine, based on the variance between the first decibel spike and the second decibel spike and at least one of the first infrared information and the second infrared information, a source location for the event. The data processing system can display, on a display device, an indication of the source location.

In some embodiments, the first acoustic information can include a timestamp corresponding to detection of the first acoustic information of the microphone, an amplitude, and a frequency. The first acoustic information can include a time series of acoustic samples. Each acoustic sample of the time series of acoustic samples can include a timestamp, amplitude, and frequency.

The data processing system can receive, from a third mobile device of the plurality of mobile devices, third location information and third infrared information. A microphone of the third mobile device can detect the third acoustic information. An infrared sensor of the third mobile device can detect the third infrared information. The data processing system can detect, based on a comparison of the third acoustic information with the threshold, a third decibel spike in the third acoustic information corresponding to the event. The data processing system can determine, based on a variance between the first decibel spike, the second decibel spike and the third decibel spike, the source location using a triangulation technique.

The data processing system can determine, based on an interaural time difference and an interaural intensity difference of the first acoustic information and the second acoustic information, the source location. The source location can include an area. The source location can include an identifier for a room in a building. The data processing system can validate, based on the first infrared information indicating a heat flash, the source location.

The data processing system can retrieve, from a data repository, a digital map corresponding to the source location. The data processing system can display the indication of the source location on the digital map. The data processing system can retrieve, from a data repository, a three-dimensional digital map corresponding to a building comprising the source location. The data processing system can display, on the three-dimensional digital map, the source location.

The data processing system can transmit, responsive to determination of the source location, the indication of the source location to a third-party device remote from the data processing system. The data processing system can identify, responsive to determination of the source location, a building control system corresponding to the source location. The data processing system can transmit a command to the building control system to cause the building control system to generate an alarm. The data processing system can identify, responsive to determination of the source location, a building control system corresponding to the source location. The data processing system can transmit a command to the building control system to cause the building control system to actuate a sprinkler system. The data processing system can identify, responsive to determination of the source location, a building control system corresponding to the source location. The data processing system can transmit a command to the building control system to cause the building control system to lock an electronically controlled door.

At least one aspect is directed to a method of distributed sensing through mobile computing devices. The method can be performed by a data processing system. The data processing system can include one or more processors. The method can include the data processing system receiving, from a first mobile device of a plurality of mobile devices, first location information, first acoustic information detected by a microphone of the first mobile device, and first infrared information. The method can include the data processing system receiving, from a second mobile device of the plurality of mobile devices, second location information, second acoustic information detected by a microphone of the second mobile device, and second infrared information. The method can include the data processing system detecting, based on a comparison of the first acoustic information with a threshold, a first decibel spike in the first acoustic information corresponding to an event. The method can include the data processing system detecting, based on a comparison of the second acoustic information with the threshold, a second decibel spike in the second acoustic information corresponding to the event. The method can include the data processing system identifying, responsive to detection of the first decibel spike and the second decibel spike, a variance between the first decibel spike and the second decibel spike. The method can include the data processing system determining a source location for the event based on the variance between the first decibel spike and the second decibel spike and at least one of the first infrared information and the second infrared information. The method can include the data processing system displaying, on a display device, an indication of the source location.

At least one aspect is directed to a system for active network security in information technology infrastructure. The system can include a data processing system and a gateway device. The data processing system can include one or more processors. The gateway device can include one or more processors. The system can include or interface with a first mobile computing device that includes one or more processors. The data processing system can provide a hash function and a routing table for storage in a block chain record. The gateway device can authenticate a first mobile computing device. The gateway device can provide, responsive to authentication of the first mobile computing device, an indication of the block chain record to the first mobile computing device. The gateway device can provide, to the first mobile computing device, a timestamp generated by a master clock to cause a client clock of the first mobile computing device to synchronize with the master clock. The first mobile computing device can determine a port number based on application of the hash function to a current timestamp generated via the client clock of the first mobile computing device synchronized with the gateway device. The first mobile computing device can hop ports based on a time interval during communication with one or more mobile computing devices connected to the gateway device.

In some embodiments, the master clock of the gateway device can correspond to a global positioning system clock. The first mobile computing device can retrieve, from the block chain record, the hash function. The first mobile computing device can detect that the gateway device entered an offline mode. The first mobile computing device can synchronize, responsive to the detection, the client clock with a remote master clock different from the master clock of the gateway device. The first mobile computing device can establish a mesh network with the one or more mobile computing device based on application of the hash function to a timestamp generated by the client clock synchronized with the remote master clock. The first mobile computing device can communicate, via the mesh network absent the gateway device, with the one or more mobile computing devices. The first mobile computing device and the one or more mobile computing devices can hop ports based on the time interval during communication with one or more mobile computing devices connected to the gateway device.

The gateway device can receive, from the first mobile computing device, a data packet configured for transmission to a second gateway device. The gateway device can determine, based on the routing table, an IP address for the second gateway device. The gateway device can forward, to the second gateway device, the data packet. The gateway device can forward the data packet to the second gateway device via an anonymous overlay network comprising a plurality of relays.

The gateway device can determine a network latency based on the authentication process executed with the first mobile computing device. The gateway device can transmit, to the first mobile computing device responsive to authentication of the first mobile computing device, a data packet comprising a first timestamp generated by the data processing system and the network latency determined based on the authentication process executed with the first mobile computing device. The gateway device can receive, from the first mobile computing device, a second timestamp generated by the first mobile computing device based on the first timestamp and the network latency. The gateway device can synchronize, based on the second timestamp received from the first mobile computing device and a ping time, the first mobile computing device.

The data processing system can determine a network latency based on the authentication process executed with the first mobile computing device. The data processing system can transmit, to the first mobile computing device responsive to authentication of the first mobile computing device, a data packet comprising a first timestamp generated by the data processing system and the network latency determined based on the authentication process executed with the first mobile computing device. The data processing system can receive, from the first mobile computing device, a second timestamp generated by the first mobile computing device based on the first timestamp and the network latency. The data processing system can ping the first mobile computing device to determine a ping time. The data processing system can determine a difference between a current time of the clock of the data processing system and half the ping time. The data processing system can determine that the first mobile computing device is synchronized with the data processing system based on the second timestamp matching the difference.

The data processing system can store an updated hash function at a subsequent block chain record. The data processing system can provide, to the gateway device, an indication of the subsequent block chain record.

The first mobile computing device can determine a hash value based on the hash function and the current timestamp. The first mobile computing device can select the port number as the hash value. The first mobile computing device can determine a message authentication code based on a message authentication process. The first mobile computing device can select the port number based on inputting the message authentication code into the hash function.

The first mobile computing device can determine a hash value based on the hash function and the current timestamp. The first mobile computing device can identify a first digit in the hash value based on the prime number. The first mobile computing device can identify a predetermined number of digits in the hash value adjacent to the first digit. The first mobile computing device can select the port number based on a combination of the first digit and the predetermined number of digits.

The data processing system can synchronize a clock of the second mobile computing device with the clock of the data processing system. The data processing system can provide, to the second mobile computing device, the hash function and the prime number to cause the second mobile computing device to select the same port number selected by the first mobile computing device to establish a communication between the first mobile computing device and the second mobile computing device.

At least one aspect is directed to a method for active network security in information technology infrastructure. The method can be performed by a data processing system having one or more processors, a gateway device having one or more processors, or a first mobile computing device having one or more processors. The method can include the data processing system providing a hash function and a routing table for storage in a block chain record. The method can include the gateway device authenticating a first mobile computing device. The method can include the gateway device providing, responsive to authentication of the first mobile computing device, an indication of the block chain record to the first mobile computing device. The method can include the gateway device providing, to the first mobile computing device, a timestamp generated by a master clock to cause a client clock of the first mobile computing device to synchronize with the master clock. The method can include the first mobile computing device determining a port number based on application of the hash function to a current timestamp generated via the client clock of the first mobile computing device synchronized with the gateway device. The first mobile computing device can hop ports based on a time interval during communication with one or more mobile computing devices connected to the gateway device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a block diagram depicting an example system for physical and information technology infrastructure security;

FIG. 2 depicts an example operational diagram for a system for active cyber defense through time-based port hopping in accordance with an implementation;

FIG. 3 depicts a flow diagram depicting an example method of active cyber defense through time-based port hopping, in accordance with an implementation;

FIG. 4 depicts a flow diagram depicting an example method of message delivery verification through retinal tracking, in accordance with an implementation;

FIGS. 5A-5C depict a flow diagram depicting an example method of distributed sensing through mobile devices, in accordance with an implementation;

FIG. 6 depicts an operational system diagram depicting an example operation of distributed sensing through mobile devices, in accordance with an implementation;

FIG. 7 depicts a flow diagram depicting an example method of distributed sensing through mobile devices, in accordance with an implementation;

FIG. 8 depicts a flow diagram depicting an example method of message delivery verification through retinal tracking, in accordance with an implementation;

FIG. 9 depicts a flow diagram depicting an example method of active cyber defense through time-based port hopping, in accordance with an implementation; and

FIG. 10 is a block diagram illustrating an architecture for a computer system that can be employed to implement elements of the systems and methods described and illustrated herein, including, for example, the systems depicted in FIGS. 1, 2, operations or examples depicted in FIG. 6, and the methods depicted in FIGS. 3, 4, 5A-5C, 7, 8 and 9.

### DETAILED DESCRIPTION

Following below are more detailed descriptions of various concepts related to, and implementations of, methods, apparatuses, and systems of providing security for physical and information technology infrastructure. The various concepts introduced above and discussed in greater detail below may be implemented in any of numerous ways.

This disclosure is directed to systems and methods of physical infrastructure and information technology infrastructure security. The technical solution can include systems and methods for distributed sensing through mobile devices, active cyber defense through time-based port hopping, and message delivery verification through retinal tracking.

The technical solution can provide multiple mobile devices detecting a decibel spike. Responsive to detecting the decibel spike, the mobile devices can use an infrared sensor (e.g., using the front facing camera) to detect a flash. The mobile device can provide an infrared measurement and a location of the mobile device to a server to allow the server to triangulate and pinpoint the origin of the sound that caused the decibel spike. The server can pinpoint the location on a map.

The distributed sensing technical solution using mobile devices can locate active events inside or outside a building. The method includes detecting quick decibel spikes and possible IR flashes using sensors present in mobile computing devices, triangulating the position of the shooter using variance of the sound volume between those mobile devices, and presenting the event's calculated location a using (3d) map on a mobile or stationary computing device. While variances of hardware within mobile devices, combined with their physical location at the time of the event, can lead to erroneous reported location for the active shooter, the technical solution can mitigate those risks by accounting for a wide distribution of the sensing software, by creating a system to drop potentially erroneous data from the triangulation calculation, by creating a database of popular mobile devices and their hardware capabilities, and by creating a database of floor plans to be used for sound reflection calculations where the system would be deployed.

The technical solution can provide active network security using block chain-based enterprise-wide port hopping. The technology can improve network security to prevent network hacks. The system can use block chain mechanics that can be coupled with digital certificates to achieve precise system-time synchronization across terminals. The system can use the time synchronization to change the communication ports of the electronic system(s) across the entire relevant system infrastructure in a pattern based on the block chain contents. The system can provide time-bound synchronization between port hopping patterns, where the frequency and pattern are based on a system time vs a starting time/sequence within a single communication, thereby providing widespread applicability for edge devices connecting to a gateway.

The port hopping protocol establishes a decentralized way to create a private secure mesh networks which would be resilient to outside attackers, preventing distributed denial of service and 51% attacks. This protocol will establish a new security standard with broad applicability for edge devices and internet of things applications. As there is a lack of ubiquity associated with atomic clocks and cellular synchronization across edge devices, the system can mitigate such risks by establishing a periodic latency-testing technique within the port hopping technique. Thus, the technical solution provides a port hopping technique that is time bound, unpredictable, amenable to low-bandwidth and low-processing-power devices, assume a mutual authentication and enrollment that is irrespective of the port hopping sequence, can be implemented for cellular phone networks, and is portable across devices common to energy, healthcare, and financial industries.

The technical solution can provide message delivery verification based on retina motion. The system can provide a read-receipt of a confidential electronic message with a security level “for your eyes only.” To do so, the system tracks retina movement of a user. The system compares the tracked retina movement with a retina movement pattern stored for the user in order to detect a match. Further, the system can track retina movement to determine whether the user read the electronic message. The system can authorize the user to read the message based on the matching retina movement pattern, and further determine whether the message was read based on retina movement. Based on this combination, the system can provide a read-receipt for the confidential electronic message.

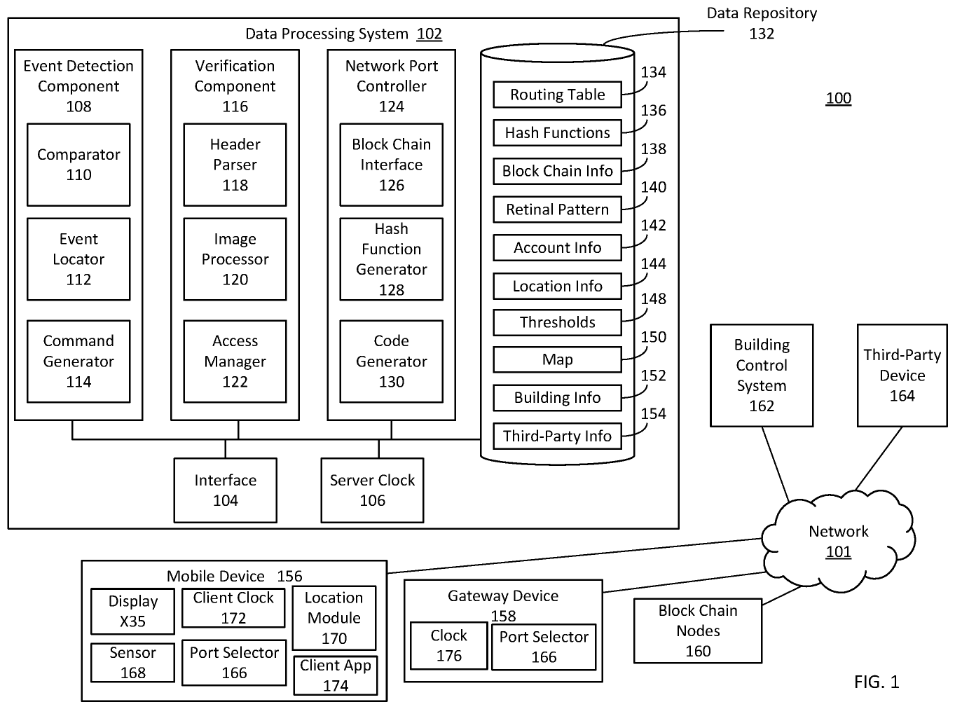

FIG. 1 depicts a block diagram depicting an example system of physical infrastructure and information technology infrastructure security. The system 100 can include at least one data processing system 102. The data processing system 102 can include at least one interface 104, at least one server clock 106, at least one event detection component 108, at least one verification component 116, and at least one network port controller 124. The data processing system 102 can include or access at least one data repository 132. The data processing system 102 can include hardware or a combination of hardware and software, such as communications buses, circuitry, processors, communications interfaces, among others.

Each of the components of the data processing system 102, mobile device 156, or gateway device 158 can be implemented using hardware or a combination of software and hardware. Each component of the data processing system 102 can include logical circuitry (e.g., a central processing unit or CPU) that responses to and processes instructions fetched from a memory unit (e.g., memory 1015 or storage device 1025). Each component of the data processing system 102, mobile device 156, or gateway device 158 can include or use a microprocessor or a multi-core processor. A multi-core processor can include two or more processing units on a single computing component. Each component of the data processing system 102, mobile device 156, or gateway device 158, can be based on any of these processors, or any other processor capable of operating as described herein. Each processor can utilize instruction level parallelism, thread level parallelism, different levels of cache, etc. For example, the data processing system 102 can include at least one logic device such as a computing device or server having at least one processor.

The components and elements of the data processing system 102, mobile device 156, or gateway device 158 can be separate components, a single component, or part of the data processing system 102, mobile device 156, or gateway device 158. For example, the event detection component 108 of the data processing system 102 (and the other elements of the data processing system 102) can include combinations of hardware and software, such as one or more processors configured to initiate stop commands, initiate motion commands, and transmit or receive timing data, for example.

One or more component or functionality of the data processing system 102 can be provided via one or more servers or via a client application 174 executed by a mobile device 156. One or more component or module of the data processing system 102 can reside or execute on the mobile device 156 via client application 174. For example, the mobile device 156, via client application 174, can execute one or more module or element of the verification component 116. The client application 174 can include on or more programs, scripts, agents, modules or function.

The system 100 can include or interface with one or more mobile devices 156. A mobile device 156 can refer to or include a mobile computing device. The mobile device 156 can include one or more processors and an interface. The interface can include, for example, one or more component or functionality of interface 104. The mobile device 156 can include or communicate with or access at least one display 1035, at least one client clock 172, at least one location module 170, at least one sensor 168 and at least one port selector 166. For example, the mobile device 156 can include or refer to a mobile telecommunications device, a smartphone, a tablet, a laptop, a wearable device, a smartwatch, smart glasses, or laptop computer. In some embodiments, the mobile device 156 can include or refer to a desktop computer. The mobile device 156 can include or execute a mobile app 174 (e.g., client application or mobile application) designed, constructed and configured to manage the one or more components of the mobile device 156 and interface with the data processing system 102.

The mobile device 156 can include at least one sensor 168. The sensor 168 can include, for example, a camera, infrared sensor, light sensor, ambient light sensor, temperature sensor, microphone, transducer, proximity sensor, accelerometer, gyroscope, motion detector, GPS sensor, or touch sensor. For example, the sensor 168 can include a microphone designed and constructed to detect acoustic signals or audio signals. The sensor 168 can detect ambient audio levels. The sensor 168 can be configured to detect audio levels on a continuous basis or based on a time interval. The sensor 168 can capture or detect acoustic signals at a range of decibels. In some cases, the sensor 168 can include or refer to multiple microphones. The mobile device 156 can configure the microphones to operate as a sound-level meter.

The mobile device 156 can include a location module 170. The location module 170 can be designed, constructed and operational to determine or provide location information. The location information can be stored in data repository 132 as a location information data structure 144. For example, the location module 170 can determine a location of the mobile device 156 via a global positioning system, cell phone tower triangulation, Bluetooth beacons, short-range wireless beacons, or Wi-Fi triangulation. In some cases, the location module 170 can provide a graphical user interface to allow a user to input, via an interface of the mobile 156, an indication of a current location. The location module 170 can determine an indoor location of the mobile device 156, such as the location of the mobile device 170 within a building, mall, library, restaurant, commercial building, residential building, apartment building, or other physical structure. The location module 170 can include, refer to or access an indoor positioning system. The location module 170 can determine an indoor location using lights, radio waves, magnetic fields, acoustic signals other sensory information. The location module 170 can perform indoor location tracking based on distance measurements relative to known nodes at fixed positions within the indoor structure, such as Wi-Fi access points, LiFi access points, beacons, magnetic positioning, or dead reckoning. The location module 170 can locate tags or detect ambient location or environmental information broadcast by a beacon to determine a location.

For example, the location module 170 can utilize a wireless (e.g., WiFi) positioning system. The location module 170 can use a localization technique to determine an indoor position or location information based on wireless access points by measuring the intensity of the received signal from the wireless access point. The location module 170 can geolocate the WiFi hotspot or wireless access point and determine an identifier of the WiFi access point such as the SSID and the MAC address of the access point.

In some cases, the location module 170 can identify a grid or dense network of low-range transmitters arranges in the physical structure or building in order to determine the indoor location information. The transmitters can broadcast a beacon or wireless signal that includes an indication of the location of the transmitter, or an identifier of the transmitter. The location module 170 can detect the broadcast and the associated indications, and determine a location of the mobile device 156, or forward the indication to the data processing system 102 to determine the location of the mobile device 156.

The data processing system 102 can include or interface with multiple mobile devices 156. The data processing system 102 can receive, from the mobile device 156, location information. The data processing system 102 can receive the location information from a location module 170 of the mobile device 156. The location information can include, for example, an address of a building or physical structure. The location information can include latitude and longitude coordinates. The location information can include an identifier associated with a building, room, area, or other position in the physical structure. For example, the location information can include an identifier of a WiFi access point, identifier of a low-range transmitter, or identifier of a Bluetooth beacon. The data processing system 102, upon receiving the location information, can determine the location of the mobile computing device 156 within the physical structure or building.

The location information can include gyroscope information, accelerometer information, or orientation information of the mobile device 156 as determined by one or more sensors 168. The data processing system 102 can use the orientation information to determine an orientation of the sensor 156 in order to perform sound location in order to determine a location of the source of the sound or the event.

The data processing system 102 can receive, from the mobile computing device 156 (e.g., via client app 174) acoustic information detected by a sensor 168. The acoustic information can include audio signals, audio waves, ambient sound level, or other auditory information. The mobile device 156 (e.g., via client app 174) can record acoustic information including a timestamp corresponding to detection of the acoustic signal by the microphone, an amplitude of the acoustic signal, or a frequency of the acoustic signal. The acoustic information can include a timestamp corresponding to when the acoustic signal was detected or a timestamp of each acoustic sample. The timestamps can be established or determined based on the client clock 172. The client clock 172 can be synchronized with the server clock 106 or some other master clock, such as a clock signal associated with a global positioning system, cellphone tower, or atomic clock. The acoustic information can include a time series of acoustic samples. Each acoustic sample of the time series of acoustic samples can include the timestamp, amplitude, and frequency information.

In some cases, the mobile device 156 can pre-process or filter the detected acoustic information prior to transmission to the data processing system 102. The mobile device 156 can determine to transmit acoustic information based on a characteristic of the acoustic signal, such as a decibel level, amplitude, or frequency. For example, the mobile device 156 can pre-process or filter the acoustic information to transmit acoustic information to the data processing system 102 that has a decibel level greater than or equal to a threshold such as, for example, 30 dB, 36 dB, 39 dB, 50 dB, 56 dB, 60 dB, 66 dB, 65 dB, 70 dB, 80 dB, 83 dB, 86 dB, or greater. The mobile device 156 can filter the acoustic information based on a low-pass frequency filter, bandpass frequency filter, or high-pass frequency filter. For example, the mobile device 156 can filter the acoustic information such that only acoustic information corresponding to a desired event is transmitted to the data processing system 102. The mobile device 156 (e.g., via client app 174) can convert the detected acoustic information from an analog signal to a digital signal prior to transmission to the data processing system 102. Thus, by pre-processing, filtering, or otherwise selectively transmitting acoustic information to the data processing system 102, the client app 174 can reduce network bandwidth utilization, battery consumption, or processor utilization.

The data processing system 102 can receive infrared information from the mobile device 156. The sensor 168 can include an infrared sensor, such as a camera, configured to detect infrared electromagnetic light waves. The infrared information can include a timestamp corresponding to when the image or light waves or signal was captured by the camera. The sensor 168 can capture images in the infrared light spectrum. The mobile device 156 can transmit the captured images or infrared information to the data processing system 102. In some cases, the mobile device 156 (e.g., via client app 174) can filter, pre-process or otherwise selectively transmit infrared information. For example, the client app 174 can determine to only transmit infrared information corresponding to a flash of heat greater than a threshold temperature. The threshold temperature can correspond to a predetermined event for event detection. For example, the threshold temperature can be, for example, over 125 degrees Fahrenheit (“F”), 150F, 175F, 195F, 200F, 220F, 250F, 275F, or 300F. Thus, by pre-processing, filtering, or otherwise selectively transmitting infrared information to the data processing system 102, the client app 174 can reduce network bandwidth utilization, battery consumption, or processor utilization.

The data processing system 102 can receive the location information, acoustic information, and infrared information from multiple mobile devices 156. For example, the data processing system 102 can receive the location information, acoustic information, and infrared information from a first mobile device and a second mobile device. The data processing system can determine that the first and second mobile devices are located within proximity to one another, or within a same physical structure, such as the same building.

The event detection component 108 can include a comparator 110 designed, constructed or operational to compare information received from the one or more mobile devices 156. The comparator 156 can access a thresholds 148 data structures stored in the data repository 132 to perform the comparison. The comparator 156 can compare acoustic information with a threshold (e.g., an acoustic threshold) to determine whether there is a decibel spike in the acoustic information. For example, the comparator 156 can receive a time series of acoustic samples and compare the acoustic samples to determine a sudden decibel spike. The comparator 110 can select a threshold 148 based on a type of event, or compare the acoustic information with multiple thresholds to determine what type of event the decibel spike corresponds to. For example, the thresholds 148 data structure can include or store an acoustic pattern or signature corresponding to a type of event (e.g., a gunshot). The comparator 110 can compare the acoustic information with the gunshot acoustic signature to determine whether there is a match (e.g., 90% similar acoustic pattern, 80% similar acoustic pattern, 70% similar acoustic pattern, 60% similar acoustic pattern or more).

For example, the comparator 110 can detect, based on a comparison of the acoustic information from a first mobile device 156 with the threshold, a first decibel spike in the acoustic information corresponding to an event. The comparator 110 can detect, based on a comparison of second acoustic information from the second mobile device 156 with the threshold, a second decibel spike in the second acoustic information corresponding to the event.

The data processing system 102 can include an event locator 112 designed, constructed or operational to locate an event. The event locator 112 can utilize the location information received from multiple mobile devices to triangulate the location of the event. For example, the event locator 112 can identify a variance between the first decibel spike and the second decibel spike associated with the acoustic information received from the respective mobile devices. The event locator 112 can determine, based on the variance between the first decibel spike and the second decibel spike and at least one of the first infrared information and the second infrared information, a source location for the event.

While variances of hardware within mobile devices, combined with their physical location at the time of the event, can lead to erroneous reported location for the event, the event locator 112 of the technical solution can mitigate those risks by accounting for a wide distribution of the sensing software, by creating a system to drop potentially erroneous data from the triangulation calculation (e.g., outlier data points), by creating a database of popular mobile devices and their hardware capabilities, and by creating a database of floor plans (e.g., map 150) to be used for sound reflection calculations where the system would be deployed.

To do so, the event locator 112 can perform sound localization. The event locator 112 can perform 3-dimensional sound location, which can refer to locating the source of the sound, such as the event, in a three-dimensional space. The event locator 112 can determine the direction of the incoming sound waves (e.g., horizontal and vertical angles) and the distance between the event and the sensor 168 that detected the acoustic signal. The event locator 112 can determine the direction of the sound using acoustic information received from multiple microphones on the mobile device 156. For example, the mobile device 156 can include a microphone array. The data processing system 102 can use the acoustic information from the multiple mobile devices 156 to form a microphone array in order to perform sound localization.

For example, the event locator 112 can obtain acoustic information from two or more mobile devices 156 in order to determine the source of the sound or the event location using a neural network, or maximum likelihood and multiple signal classification. The event locator 112 can determine the source location on an interaural time difference and an interaural intensity difference of the acoustic information and the acoustic information received from the multiple mobile devices 156. The time difference can refer to the difference in time stamps associated with the acoustic samples or acoustic information received from different mobile devices. For example, the event locator 112 can identify a timestamp corresponding to a first decibel spike in the first acoustic information and a timestamp corresponding to the second decibel spike in the second acoustic information. The timestamps can correspond to when the respective mobile devices 156 detected the decibel spike. The first and second decibel spike can correspond to a same event, such as a gunshot. The event locator 112 can determine a location based on the difference in interaural time between the detected decibel spike. The event locator 112 can determine the interaural intensity difference based on the different decibel values of the first decibel spike and the second decibel spike.

The event locator 112 can perform acoustic source localization based on the acoustic information. The acoustic information can include information regarding the sound field, such as sound pressure and particle velocity. The sensor 168 can measure or record sound pressure using a polar pattern indicating the sensitivity of the microphone as a function of the direction of the incident sound.

The event locator 112 can use a time difference of arrival technique to determine the source direction. The arrival time of the acoustic wave can be recorded with the acoustic information by the mobile device 156 or client app 174. Using acoustic information from at least two mobile devices 156, the event locator 112 can use a cross-correlation function to determine the level of correlation between the two acoustic signals as follows:

$${R}_{{x}_{1} , {x}_{2}} ( τ ) = {\sum }_{n = - ∞}^{∞} {x}_{1} ( n ) {x}_{2} ( n + τ )$$

This equation can provide the level of correlation between two mobile devices x1 and x2. A higher level of correlation can indicate that tau is relatively close to the actual time-difference-of-arrival.

The interaural time difference can be determined

$$Δ t = \frac{x cos θ}{c}$$

Where delta t refers to the time difference in seconds (e.g., different between timestamps corresponding to the decibel spikes), x refers to the distance between the two mobile devices based on the received location information from the mobile devices, and theta is the angle between the baseline of the sensors and the incident sound.

The event locator 112 can use triangulation to determine the location of the event or source of the sound. Triangulation can refer to the process of determining the location of a point by measuring angles to it from known points at either end of a fixed baseline. The point can then be fixed as the third point of a triangle with one known side and two known angles. The event locator 112 can perform triangulation by measuring the source from two or more locations (e.g., by two or more mobile devices) in space.

For example, the data processing system 102 can receive, from a third mobile device 156, third location information, third acoustic information detected by a microphone of the third mobile device, and third infrared information. The data processing system 102 can detect, based on a comparison of the third acoustic information with the threshold, a third decibel spike in the third acoustic information corresponding to the event. The data processing system 102 can determine, based on a variance between the first decibel spike, the second decibel spike and the third decibel spike, the source location using a triangulation technique.

Thus, the event locator 112 can determine the source location information based on the acoustic information and location information received from multiple mobile devices 156. The event locator 112 can further determine the source location based on the infrared information received from at least one of the mobile devices 156. For example, the event locator 112 can determine, from infrared information from a mobile device 156, that there was a heat flash in the room in which the mobile device 156 is located. Based on the detection of the heat flash in the infrared information, the data processing system 102 can determine that the source of the event is near or proximate to the mobile device 156 or within the room.

The data processing system 102 can determine the intensity of the heat flash based on the infrared information in order to validate the source location determined based on the acoustic information received from the multiple devices 156. For example, the event locator 112 can determine based on the acoustic information from multiple devices 156 two candidate locations for the source of the event. The event locator 112, using the infrared information, can then determine which of the two candidate locations is more likely to be the location of the event. For example, if the infrared information indicates a heat flash of 300 F in the first candidate location, then the event locator 112 can select the first candidate location as the location of the event. The event locator 112 can use image interpretation algorithms or an image processor to analyze or interpret the infrared information in order to determine or validate the source location.

The source location (or event location) can include an area, or an identifier for a room in a building. An area can refer to an area within a building, such as a lobby, entrance, exit, wing, courtyard or other area. The event locator 112 can access the data repository 132 to obtain map information from the map data structure 150. The map data structure 150 can include a two-dimensional or three-dimensional map of the building in which the mobile device 156 is located. The event locator 112 can correlated the source location with rooms or locations indicated in the map of the building in order to determine an identifier (e.g., alphanumeric identifier, floor, or name) of a room corresponding to the source location. The data processing system 102 can retrieve, from the data repository 132, a digital map (or three-dimensional digital map including different floors of the building) from the map data structure 150 corresponding to the source location, and display the indication of the source location on the digital map.

The data processing system 102 can display the indication of the source location on a display device. The display device (e.g., display 1035) can be communicatively coupled to the data processing system 102.

The event detection component 108 can include a command generator 114 designed, constructed or operational to generate or provide commands based on locating the event. The command generator 114 can provide or transmit commands via network 101. The command generator 114 can provide commands to the mobile device 156, a building control system 162, or a third-party device 164. Information related to the third-party device 164 can be stored in a third-party information data structure 154 in data repository 132, and include, for example, identifiers, phone numbers, categorizations or other information to facilitate communication with the third-party device 164.

A building control system 162 can refer to a system that controls one or more electrical components in a building, such as lighting, electronic door locks, automatic doors, sprinkler system, alarm system, automatic window shades, etc. The building control system 162 can interface or communicate with the data processing system 102. The data processing system can identify a building control system 162 based on building info 152 stored in data repository 132. The building info data structure 152 can include identifiers for a building, IP address for a building control system 162 corresponding to the building having the source location, parameters of the building control system 162, functionality of the building control system 162, command generation formats for the building control system 162 or other information to facilitate communication with the building control system 162.

The command generator 114 can identify, responsive to determination of the source location, a building control system 162 corresponding to the source location using the building information data structure 152. The command generator 114 can generate and transmit a command to the building control system 162. For example, the command can cause the building control system 162 to generate an alarm, generate an audible alarm, generate a visual alarm, turn on a sprinkler system, lock automatic doors, or open automatic doors. The command generator 114 can generate a command corresponding to the source location, for example to turn on or actuate a sprinkler in the room in which the event occurred.

The data processing system 102 can transmit commands or indications to a third-party device 164. The third-party device 164 can refer to or include law enforcement, drones, first responders, a police department, fire department, ambulance, security entity, government or municipal entity, or other entity or service or device. The third-party device 164 can be remote from the source location or the data processing system 102. The command generator 114 can transmit, responsive to determination of the source location, the indication of the source location to the third-party device 164.

The data processing system 102 can include a verification component 116 designed, constructed and operational to provide electronic message delivery verification. The mobile device 156 can execute or provide one or more component, element of functionality of the verification component 116. For example, the verification component 116 can execute on the mobile device 156. The client application 174 can include or execute the verification component 116, or interface with one or more module of the verification component 116 executing on the data processing system 102.

The verification component 116 can provide or facilitate authentication, electronic message receipt confirmation or verification, message security, or message confidentiality. The verification component 116 can include or execute a header parser 118. The header parser 118 can be configured to receive or detect an electronic message, such as electronic mail or e-mail. The electronic message can include a header and a body or payload. The header of the electronic information can include information regarding the sender of the electronic message (e.g., a sender identifier, username, IP address) and information about the recipient of the electronic message (e.g., recipient identifier, username, or IP address). The header can include a date, timestamp, subject, or CC field. The electronic message can include, in the header, information about the electronic message or characteristics of the electronic message. The header can include, for example, a security level of the electronic message, a format of the electronic message, a confidentiality level of the electronic message, a request for a read receipt, or a request for a delivery receipt. The header parser 118 can parse this header information to detect whether the electronic message includes a security flag. The electronic message can be sent from a sender computing device (e.g., mobile device 156 or sender mobile device 156) to a recipient computing device (e.g., mobile device 156 or recipient mobile device). The sender and recipient mobile devices can be different mobile devices. The electronic message can be sent from the sender computing device to the recipient computing device via a network 101.

The network 101 can include computer networks such as the Internet, local, wide, metro, or other area networks, intranets, satellite networks, and other communication networks such as voice or data mobile telephone networks. The network 101 can be used to access information resources such as web pages, web sites, domain names, or uniform resource locators that can be presented, output, rendered, or displayed on a mobile device 156. The network 101 can be used to access or facilitate communications between two or more of the data processing system 102, mobile device 156, gateway device 158, block chain nodes 160, building control system 162, or third party device 164.

The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 may include a wireless link, such as an infrared channel or satellite band. The topology of the network 101 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The verification component 116 can receive retinal eye movement information tracked by a sensor 168 of the mobile device 156. For example, the sensor 168 can include a camera. The camera can be a front-facing camera in that the camera can face a same direction that display output is provided. The camera can be located adjacent or proximate to the display 1035 in order to capture the user's eye movement, retina movement, retina location, or eye focus. The camera can be configured to capture a visual feed or take pictures or a video stream as the user views the electronic message.

For example, responsive to detection of the security flag, the client application 174 (or verification component 116) can capture or receive retinal eye movement information tracked by the camera of the recipient computing device (e.g., mobile device 156) during display of the electronic message. To reduce processor utilization, data file size, or battery consumption, the client application 174 can control the camera to obtain or capture a video feed only for electronic messages having the security flag or other instruction, indication or command to obtain a video feed to facilitate verification. The security flag can be set by the data processing system 102, the sender computing device (e.g., a client application 174 executing on the sender mobile device) a mail server, or other intermediary device that facilitates transmitting, relaying or otherwise providing the electronic message.

The client application 174 can identify a retinal eye movement pattern corresponding to an account identifier associated with the recipient computing device. The client application 174 can query the data processing system 102 to obtain the retinal eye movement pattern stored in a retinal pattern data structure 140 in the data repository 132. The retinal pattern can correspond to a retinal movement signature of a user of the mobile computing device 156. The retinal pattern can correspond to biometric information associated with a user associated with an account. The retinal pattern can be unique to the user. The retinal pattern can be determined or obtained during a training process or account setup process. For example, the user can establish an account profile (e.g., account info 142) that includes the user's retinal eye movement information.

The image processor 120 can perform eye tracking. Eye tracking can refer to or include measuring a point of gaze (e.g., where the eye or retina or fovea of a user is looking), or a motion of an eye relative to the head of the user. The image processor 120 can measure eye positions and eye movement. The image processor 120 (which can be referred to as an eye tracker component) can extract eye position from video images captured by the camera (e.g., sensor 168).

The image processor 120 can use an optical method for measuring eye motion. Light (e.g., infrared) can be reflected from the eye and sensed by a video camera (e.g., sensor 168). The image processor 120 can analyze the information to extract eye rotation from changes in reflections. The image processor 120 can track various aspects of the eye. The image processor 120 can use the corneal reflection and the center of the pupil as features to track over time. The image processor 120 can uses reflections from the front of the cornea and the back of the lens as features to track. The image processor 120 can track image features from inside the eye, such as the retinal blood vessels, and follow these features as the eye rotates.

The camera (e.g., sensor 168) can focus on one or both eyes and record eye movement as the viewer looks at the electronic message. The verification component 116 can use the pupil and infrared/near-infrared non-collimated light to create corneal reflections (CR). The verification component 116 can use the vector between the pupil center and the corneal reflections can to compute the point of regard on surface or the gaze direction. The verification component 116 can use infrared/near-infrared (also known as active light) eye-tracking techniques, such as bright-pupil and dark-pupil. The verification component 116 can use bright-pupil tracking as it can create greater iris/pupil contrast, allowing more robust eye-tracking with all iris pigmentation, and reduces interference caused by eyelashes and other obscuring features, while allowing tracking in lighting conditions ranging from total darkness to very bright.

Based on the captured eye movement images, the image processor 120 can generate retinal eye movement information which can correspond to an eye movement signature or pattern that can be unique to the user of the recipient computing device or account information. The eye movement signature can include eye motion characteristics, such as motion, speed, direction, vectors, or other eye motion characteristics. The signature can include eyelid blink rate. The eye movement signature can be based on a task, such as an eye movement signature for the user when the user reads an electronic message. For example, the eye movement signature or information can vary for a user based on the type of task the user is performing (e.g., watching a video versus reading an electronic message).

Thus, the image processor 120 can obtain the retinal eye movement information captured by the camera of the mobile device 156 and compare it with the retinal pattern received from the data repository 132. The image processor 120 can determine, based on a comparison of the tracked retinal eye movement with the retinal eye movement pattern, whether there is a match. A match can indicate that the captured retinal eye movement matches or is similar to the pattern stored in the data repository 132.

The verification component 116 can include an access manager designed, constructed or operational to provide message receipt confirmation, authentication, message security or message confidentiality. For example, the access manager 122 can transmit, responsive to the match, a read notification to the sender computing device. If the retinal eye movement does not patch the pattern, then the access manager 122 may not send the read confirmation receipt. The retinal eye movement information can be captured while an electronic message is displayed on the mobile device 156 via the display 1035. Thus, a match between the retinal movement information and the pattern can indicate that the user read the electronic message, whereas a mismatch can indicate that the user did not read the electronic message.

The mobile device 156 can determine whether the authorize or authenticate the user before displaying the message. For example, the mobile device 156 can receive biometric information captured prior to display of the electronic message on the mobile device 156 (e.g., recipient computing device). The biometric information can include, for example, fingerprint, retinal scan, retinal eye movement, voice signature, or acoustic fingerprint. The mobile device 156 can determine to authorize, based on a match between the biometric information and account information corresponding to the account identifier (e.g., account information 142 retrieved from the data repository 132), the recipient computing device to display the electronic message. For example, the mobile device 156 can capture an initial retinal eye movement information prior to display of the electronic message on the mobile device 156. The mobile device 156 can determine to authorize, based on a match between the initial retinal eye movement information and the stored initial retinal eye movement pattern for the account identifier, the mobile device 156 to display the electronic message.

In the absence of matches, the mobile device 156 can determine to block access, prevent display, or terminate display of the electronic message in order to prevent or mitigate unauthorized access to the electronic message. For example, the verification component 116 can detect that an electronic message contains a security flag. The security flag can indicate to provide a read notification based on retinal eye movement. The verification component 116 can capture retinal eye movement information while the electronic message is displayed on display 1035. The verification component 116 can determine, based on a comparison of the retinal eye movement with the retinal eye movement pattern, an absence of a match. For example, the level of match or similarity can be less than 90%, 80%, 70%, 65%, 60%, or less. The verification component 116 can block, prevent, or determine not to transmit a read notification for the electronic message to the sender computing device responsive to the absence of the match. Not sending the read notification can reduce network bandwidth utilization. In some cases, the verification component 116 can transmit, responsive to the absence of the match, an indication that the electronic message is unread. For example, the verification component 116 can indicate that the message was displayed on the display 1035, but was not read because the user did not focus on the electronic message. In some cases, the verification component 116 can transmit, responsive to the absence of the match, an indication that the electronic message was delivered and unread. The verification component 116 can transmit, responsive to the absence of the match, an indication that the electronic message was displayed on the recipient computing device and is unread.

The verification component 116 can determine the amount of time or duration that the retinal eye movement matches the pattern during display of the electronic message. If the duration of the match satisfies a threshold (e.g., a duration threshold stored in thresholds data structure 148 in data repository 132), then the verification component 116 can determine that the message was read. For example, the verification component 116 can determine a duration of the match between the retinal eye movement and the retinal eye movement pattern is greater than or equal to a duration threshold. The verification component 116 can transmit the read notification responsive to the duration being greater than or equal to the duration threshold. The read notification comprises an indication of the duration (e.g., the number of seconds or minutes of the duration of the match). The verification component 116 can determine a duration of the match between the retinal eye movement and the retinal eye movement pattern is less than or equal to a duration threshold, and transmit, responsive to the duration of the match less than or equal to the duration threshold, an indication that the electronic message is unread. Thus, even if there is a match, the verification component 116 can mark the message unread if the duration of the match is less than a duration threshold.

The verification component 116 can use a policy to determine whether to transmit an indication responsive to a mismatch, and select an indication to transmit. The policy can be indicated in the security flag. For example, the security flag can include an indication of the type of message indication the recipient desires, and the verification component 116 can provide the corresponding indication. The policy can be set by the sender computing device or the recipient computing device, such as in account information data structure 142.

The verification component 116 can determine to terminate display of the electronic message. For example, the verification component 116 can determine, based on initial retinal eye movement information captured during display of the electronic message, a match with the retinal eye movement pattern to determine that an authorized user is viewing or reading the electronic message. However, subsequently the verification component 116 can capture second retinal eye movement information and determine that the subsequent retinal eye movement information does not match (is a mismatch or an absence of a match) with the pattern. The mismatch may indicate that an unauthorized user obtained the mobile device 156 and is attempting to view the electronic message, or that the authorized user is no longer focusing on the electronic message or reading the electronic message (e.g., is no longer looking at the display 1035). To maintain security, mitigate unauthorized access to the electronic message, or reduce the amount of time confidential information is displayed, the verification component 116 can terminate, based on a mismatch between the second retinal eye movement and the retinal eye movement pattern, display of the electronic message on the recipient computing device.

The data processing system 102 can include a network port controller 124 designed, constructed and operational to facilitate time-based port hopping and packet route anonymization in a network 101 or at least a portion of the network 101. The network port controller 124 can include at least one block chain interface 126, at least one hash function generator 128, and at least one code generator 130. The block chain interface 126 can be designed, constructed and operational to interface with one or more block chain nodes 160. The mobile device 156 can also include a block chain interface 126. Information associated used to communicate or interface with the block chain nodes 160 can be stored in a block chain information data structure or data file 138 in the data repository 132. This information can include a key or identifier used to access the block chain record.

The block chain interface 126 can be designed, constructed or operational to communicate with one or more block chain systems or block chain nodes 160 to conduct a block chain transaction or store information in a block chain record. The block chain interface 126 can communicate with the block chain nodes 160 via a block chain API.

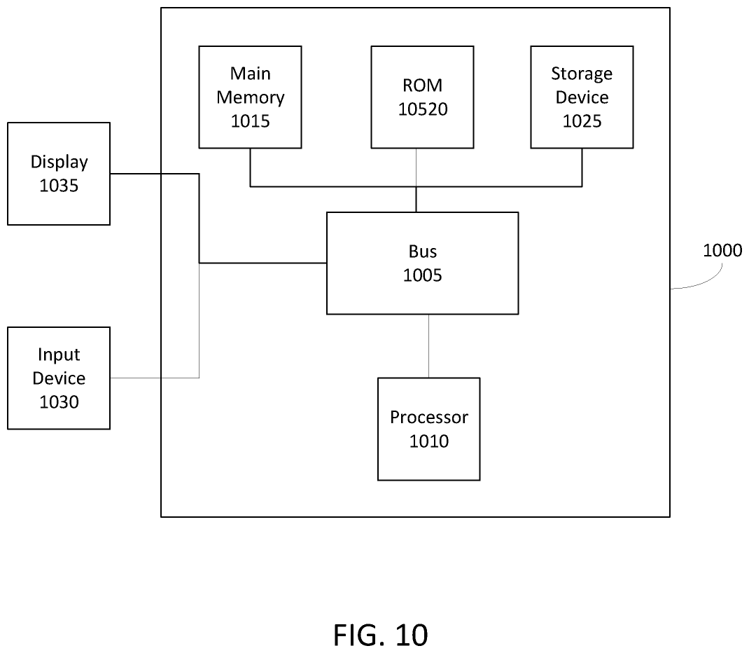

Block chain nodes 160 can be composed of, or otherwise utilize multiple computing nodes. The block chain nodes can include one or more component or functionality of computing system 1000 depicted in FIG. 10. The block chain nodes 160 can generate, store or maintain a block chain record. The block chain record can correspond to a block chain address. The block chain record can include one or more blocks. The blocks in the block chain can refer to or correspond to a block chain transaction. The block chain nodes 160 can include a distributed network of nodes (e.g., computing systems or computing devices) that store the block chain records having a block chain address or block chain certificate. Each block at the block chain address or certificate can include a cryptographic hash of a previous block in the block chain address.

A block chain (or blockchain) can refer to a growing list of records (or blocks) that are linked and secured using cryptography. Each block can include a cryptographic hash of a previous block as well as contain content or other data. The block chain can be resistant to modification of the data stored in the block. The block chain can be an open, distributed record of electronic transactions. The block chain record can be distributed among the computing nodes 160. For example, each of the computing nodes 160 can store a copy of the block chain record. The computing notes 160 can refer to or form a peer-to-peer network of computing nodes collectively adhering to a protocol for inter-node communication and validating new blocks of the block chain record. Once recorded, the data in any given block cannot be altered retroactively without alteration of all subsequent blocks, which requires collusion of the majority of the computing nodes 160.

By maintaining the block chain record in a decentralized, distributed manner over the network formed by computing nodes 160, the record cannot be altered retroactively without the alteration of all subsequent blocks and the collusion of the network. The block chain database (e.g., block chain record) can be managed autonomously using the peer-to-peer network formed by computing nodes 160, and a distributed timestamping server.

Each block in the block chain record can hold valid transactions that are hashed and encoded into a hash tree. Each block includes the cryptographic hash of the prior block in the block chain, linking the two. The linked blocks form a block chain record. This iterative process can confirm the integrity of the previous block, all the way back to the original genesis block.

The hash function generator 128 of the network port controller 124 can generate or identify a hash function to use for port hopping. Generating a hash function can refer to or include retrieving a hash function from a hash functions 136 data structure or data repository 132. Generating the hash function can include adjusting a key, or seed value used in the hash function, or some other parameter used in the hash function. For example, generating the hash function can include inputting a random number into the hash function. The hash function generator 128 can store the generated hash function at a block chain address on a block chain node. The block chain node can distribute the hash function across other block chain nodes 160. Example hash functions stored in hash function database 136 can include MD5, Bernstein hash, Fowler-Noll-Vo hash function, SHA-2 (secure hash algorithm 2), etc.

The data processing system 102 can also store a routing table on the block chain. The routing table can be retrieved from the data repository 132, such as from routing table data structure 134. The routing table 134 can refer to or include a list of IP addresses for gateway devices 158. The routing table can include a list of IP addresses for gateways that are configured to use a time-based port hopping and packet anonymization process. The routing table can include a list of Tor gateways configured to directed network traffic through a free, worldwide, volunteer overlay network.

The data processing system 102 can periodically update the block chain record with an updated hash function. The updated hash function can be stored at a subsequent block in the block chain. The data processing system 102 can periodically (e.g., every 6 hours, 12 hours, 24 hours or other time interval) generate an updated hash function, code, random number, routing table, or other value for use in time-based port hopping, and store the value at a next block in the block chain. The data processing system 102 can provide an indication of the subsequent block in the block chain to the gateway device 158 to use the updated hash function provide.

The system 100 can include a gateway device 158. The gateway device 158 can refer to or include a network access point. The gateway device 158 can include networking hardware used in telecommunications for telecommunications networks that allows data to flow from one discrete network to another. The gateway device 158 can communicate one or more than one network protocol, and can operate at any of the seven layers of the open systems interconnection model (OSI). The gateway device 158 can include a computer or computer program configured to perform the tasks of a gateway, such as a default gateway or router. The gateway device 158 can provide provides interoperability between networks and can contain devices, such as protocol translators, impedance matching devices, rate converters, fault isolators, or signal translators, as necessary to do so. The network gateway 158 can perform protocol conversions to connect networks with different network protocol technologies.

On an Internet protocol (IP) network, IP packets with a destination outside a given subnet mask can be sent to the network gateway. For example, if a private network has a base IPv4 address of 192.168.0.0 and has a subnet mask of 255.255.255.0, then any data addressed to an IP address outside of 192.168.0.X can be sent to the network gateway. IPv6 networks work in a similar way. While forwarding an IP packet to another network, the gateway may perform network address translation.

The gateway device 158 can authenticate one or more mobile devices 156 to communicate on the network with the gateway device 158. The gateway device 158 can use various authentication techniques. For example, the gateway device 158 can authenticate the mobile device 158 based on a username, password, IP address, MAC address of the mobile device 158, certificate, token, other authentication technique.

The gateway device 158 can provide an indication of the block chain address to the mobile computing device 158. The gateway device 158 can provide the indication of the block chain address or record responsive to authenticating the mobile computing device. The indication of the block chain record can include an address of the block chain record. The block chain address can correspond to the block chain record at which the data processing system 102 stored the hash function and routing table.

The gateway device 158 can perform a clock synchronization process. For example, the gateway device 158 can provide, to the mobile device 156, a timestamp. The timestamp can be generated by a master clock (e.g., a server clock 106 or GPS clock) to cause a client clock 172 of the mobile device 1056 to synchronize with the master clock. The server clock 106 or master clock can be based on global positioning system clock, satellite based clock, atomic clock, cell phone system clock or other master clock.

To synchronize the client clock 172, the gateway device 158 can determine a network latency based on the authentication process executed with the mobile device 156. For example, during a handshaking process, the gateway device 158 can determine the latency of the network. The network latency can be determined by pinging the mobile device 156 to obtain a ping time. The gateway device 158 can transmit, to the mobile device 156 responsive to authentication of the mobile device 156, a data packet that includes a first timestamp generated by the gateway device 158 and the network latency determined based on the authentication process executed with the first mobile computing device. The gateway device 158 can then receive, from the mobile device 156, a second timestamp generated by the mobile computing device based on the first timestamp and the network latency. The gateway device 158 synchronize, based on the second timestamp received from the mobile computing device and a ping time, the mobile device 156. The gateway device 158 can ping the mobile device 156 to determine a ping time, and determine a difference between a current time of the master clock and half the ping time in order to account for a one-way travel time over the network. The gateway device 158 can receive subsequent time stamps from the client clock 172 and account for the network travel time in order to determine whether the client clock 172 is synchronized with a gateway clock 176. The gateway device 158 can determine that the mobile device 156 is synchronized with the gateway clock 176 or server clock 106 or other master clock based on the subsequent timestamps matching.

Thus, the mobile device 156 can determine a time offset between the client clock 172 and a master clock, clock of the gateway device 158, or server clock 106. Upon determining the offset of the client clock 172 relative to a master clock, the mobile device 156 can either adjust the client clock 172 to remove the offset, or can account for the offset when generating a current time stamp for input into the hash function in order to determine a port number.

The gateway device 158 can transmit, via the network, the block chain address and timestamp to the mobile device 156. The mobile device 156, upon receiving the block chain address, can access the block chain nodes 160 to retrieve the data stored at the block chain record corresponding to the block chain address. The mobile device 156 can retrieve the hash function stored at the block chain record. The mobile device 156 can include a block chain interface 126 configured to access the block nodes 160 and retrieve the data stored at the block chain record by the data processing system 102.

The mobile device 156 can include a port selector 166 designed, configured or operational to determine a port number. The mobile device 156 (e.g., via port selector 166) can use the hash function to determine a port number by inputting a current timestamp into the hash function to generate a hash value. The output hash value can be used as the port number or be used to determine the port number. Since the client clock 172 is synchronized with the server clock 106 (or master clock) and the gateway device 158 can also be synchronized with the server clock 106 (or master clock), the current timestamp generated by the client clock 172 can match the current timestamp generated by the gateway device 158. Thus, by using the same hash function, both the mobile device 156 and the gateway device 158 can output the same hash value. Based on the same hash value, both the mobile device 156 and gateway device 158 can select the same port number for subsequent communications. For subsequent timestamps, the mobile device 156 and the gateway device 158 can hop ports or change port numbers. The one or more mobile device 156 and gateway device 158 can hop or change port numbers based on a time interval (e.g., every 10 seconds, 30 seconds, 60 seconds, 90 seconds, 2 minutes, 5 minutes, 10 minutes, 20 minutes, 30 minutes, 60 minutes, 90 minutes, 2 hours, 6 hours, 12 hours, 24 hours, 36 hours, 48 hours or some other time interval).

The mobile device 156 can select the port number based on the hash value. For example, the port number can be the hash value or a predetermined set of digits of the hash value. The predetermined set of digits of the hash value can refer to the first four or five digits of the hash value, last four or five digits of the hash value or other set of four or five digits in the hash value.

The port selector 166 can select the port number based on the hash function and the current timestamp. The port selector 166 can select the port number based on a combination of the current timestamp and a random number or code. The port selector 166 can select the port number based on the combination of a hash value and the random number or code. For example, the data processing system 102 can store, at the block chain record, a random number or code, such as a large prime number. The data processing system 102 can include a code generator 130 designed, constructed and operational to generate the random number, code or large prime number. The code generator 130 can include a random number generator (e.g., a hash function configured to receive a seed value and then propagate that value to determine a random number). The code generator 130 can retrieve the large prime number from the data repository 132. The code generator 130 can generate any type of numerical code based on any function, script, or database. The code generator 130 can provide the code for storage at the block chain record along with the hash function.

The port selector 166 can determine a message authentication code based on a message authentication process. The message authentication code can be referred to as a tag and can include information used to authenticate a message, such as to confirm that the message came from the stated sender (its authenticity) and has not been changed. The message authentication code value protects both a message's data integrity as well as its authenticity, by allowing verifiers (who also possess the secret key) to detect any changes to the message content. The message authentication code can be generated by a message authentication process that uses one or more functions, such as a key generation function to select a key from the key space uniformly at random, a signing function to returns a tag given the key and the message, and a verifying function to verify the authenticity of the message given the key and the tag. The port selector 166 can select the port number based on inputting the message authentication code into the hash function.

The port selector 166 can use the code to select the port number from the hash value output by application of the hash function to the current timestamp generated by the synchronized client clock 172. For example, the port selector 166 can use the random number to indicate a digit in the hash value to select as a first digit for the port number, and then select the subsequent three or four digits to create the port number.

The mobile device 156 can use the time-based port hoping technique to generate an ad hoc mesh network to communicate with other mobile devices 156 without communicating through the gateway device 158. For example, should the gateway device 158 go offline, fail, enter a standby mode, or otherwise cease operation, mobile devices 156 that were linked or previously authenticated with the gateway device 158 can continue to communicate with one another using the time-based port hopping technique by inputting the current time stamp generated from a synchronized clock into the hash function retrieved from the block chain record to determine a port number to use.

For example, the mobile device 156 can detect that the gateway device 158 entered an offline mode. The mobile device 156 can synchronize, responsive to the detection, the client clock 172 with a remote master clock different from the master clock of the gateway device. For example, the mobile device 156 can synchronize with a cell phone tower clock or GPS clock, or other clock. The mobile device 156 can establish a mesh network with the one or more mobile devices 156 based on application of the hash function to a timestamp generated by the client clock synchronized with the remote master clock. The mobile device 156 can communicate, via the mesh network absent the gateway device, with the one or more mobile computing devices. The mobile devices 156 can hop or switch port numbers ports based on the time interval during communication with one or more mobile computing devices connected to the gateway device 158.

The gateway device 158 can facilitate communication among other gateway devices 158. For example, the gateway device 158 can receive, from the mobile device 156, a data packet configured for transmission to a second gateway device 158 in a different subnetwork. The gateway device 158 can determine, based on the routing table retrieved from the block chain record stored by the data processing system 102, an IP address for the second gateway device 158. The gateway device 158 can forward, to the second gateway device, the data packet. The gateway device 158 can forward the data packet to the second gateway device via an anonymous overlay network comprising a plurality of relays indicated by the routing table. Thus, by communicating via gateway devices 158 that are established or identified by the data processing system 102 as using the time-based port hopping technique, the system 100 can facilitate secure network communications across various gateway devices 158.

The gateway device 158 can synchronize one or more clocks of one or more mobile devices 156 to allow the mobile devices 156 to communicate with each other using the same time-based port hopping technique, or to communicate with the gateway 158. For example, the gateway device 158 can provide, to a second mobile device 156, the hash function and a prime number (or other code generated by the code generator 130) to cause the second mobile device 156 to select the same port number selected by a first mobile device 156 to establish a communication between the first mobile device 156 and the second mobile device 156.

The mobile devices 156 can be referred to as authenticated devices or authenticating devices as the mobile devices may be continuously or periodically authenticated with or by the gateway device 158. The mobile devices can be authenticated for each transmission.

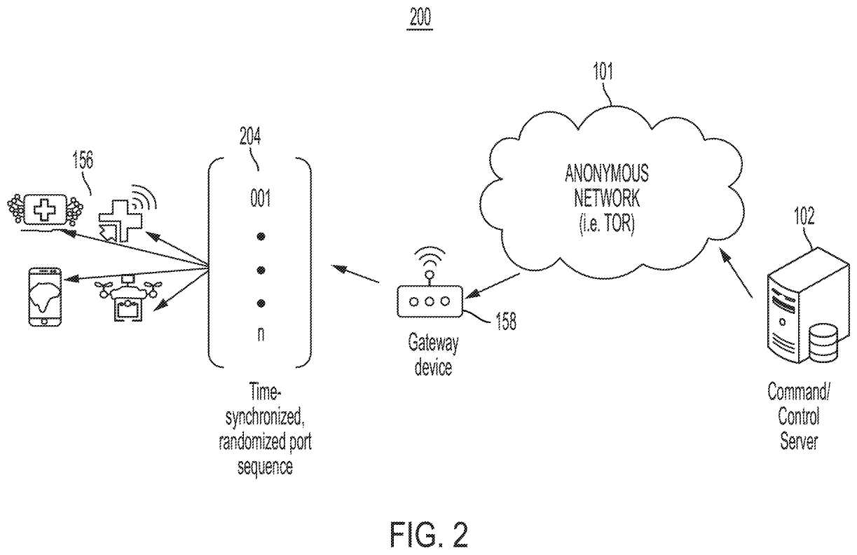

FIG. 2 depicts an example operational diagram for a system for active cyber defense through time-based port hopping in accordance with an implementation. The system 200, or operations thereof, can include or be performed by one or more component or functionality of system 100 depicted in FIG. 1, including, for example, a data processing system 102, network 101, gateway device 158 and mobile device 156.

As depicted in system 200, the gateway device 158 can provide information for a time-synchronized, randomized port sequence. This information can include a hash function obtained from a block chain record provided by a command/control server 102 (e.g., data processing system 102 depicted in FIG. 1). The mobile devices 156 (or edge devices or other computing devices including a drone device) can use the port sequence 202 to perform port hopping. The mobile devices 156 can include a port selector configured to determine the port number, and switch to the next port number. Thus, the system 200 can provide for enterprise-wide time-based port hopping using information retrieved from a block chain record.

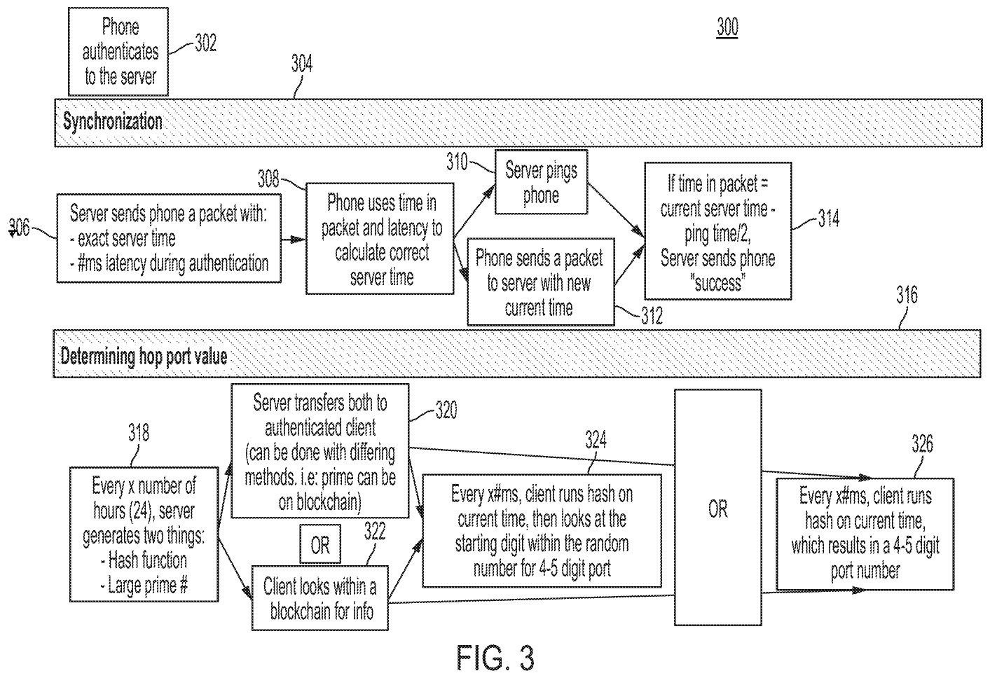

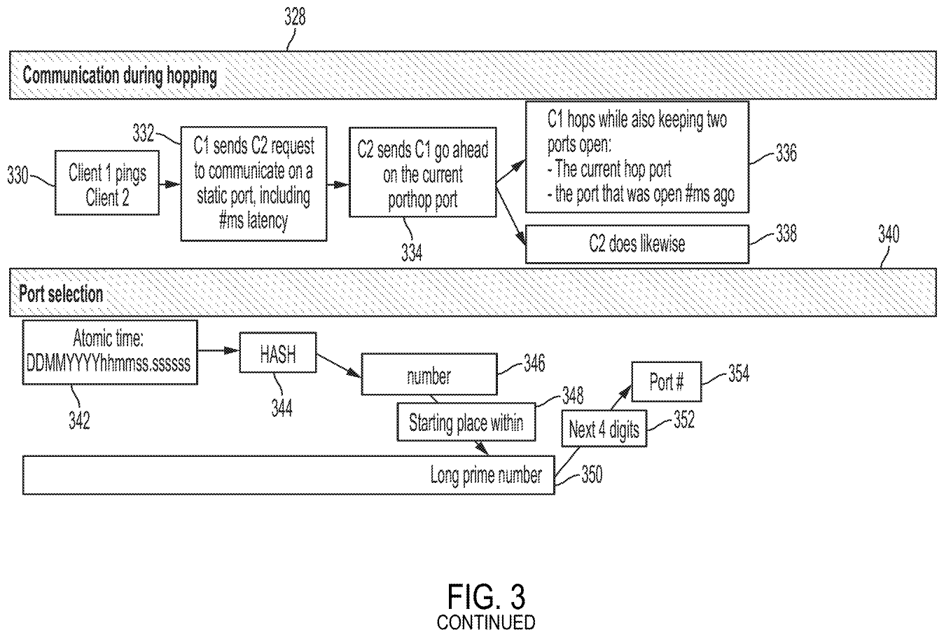

FIG. 3 depicts a flow diagram depicting an example method of active cyber defense through time-based port hopping, in accordance with an implementation. The method 300 can be performed by one or more component or functionality of system 100 depicted in FIG. 1, including, for example, a data processing system 102, network 101, gateway device 158 and mobile device 156. AT 302, a mobile device can authenticate to a server, such as data processing system 102. At 304, the system can perform a synchronization process, which can include the server sending the mobile device a data packet at 306. The data packet can include the exact server time and latency during authentication. At 308, the mobile device can use the time in the packet and latency to calculate a correct or current server time (e.g., provided time plus one-way network travel time). AT 310, the server (or a gateway device or data processing system) pings the mobile device and at 312 the mobile device sends a packet to the server with a new current time. At 314, the server (e.g., gateway or data processing system) can determine whether the time in the packet is correct and synchronized if the packet time equals the difference between the current server time and half the ping time (e.g., one-way network latency time). If yes, then synchronization 304 is a success.

At 316, the system can determine a port hop value. At 318, the server can generate a hash function. The server can also generate a code, large prime number or other random number. The server can store the hash function and code in a block chain record. The server can send the hash function to the authenticated and synchronized mobile device at 320, or the client can retrieve the information from the block chain at 322. At 324, the client can run the hash function on the current time generated from the synchronized clock and use the random number to determine the port number, or the client can run the hash on the current time to determine the port number at 326.

At 328, the system can communicate during port hopping. To communicate during port hopping, a first client mobile device can ping the second mobile device at 330. The first mobile device can send the second mobile device a request to communicate on a static port, and include a latency time at 332. AT 334, the second client computing device can send the first client computing device a go ahead on the current port hop port. At 336 and 338, the first client device and second client device can hop ports while also keeping two ports open (e.g., the current hop port and the port that was open previously).

At 340, the mobile devices or system devices can perform port selection. The mobile device or client device or other system device can determine a current time at 342 (e.g., an atomic time or time based on a master clock or synchronized clock). At 344, the mobile device can input the atomic time into a hash function. At 346, the mobile device can output a hash value from the hash function, which can be a number. At 348, the mobile device can determine a starting place within the number using a prime number retrieved from the block chain at 350. At 352, the mobile device can determine the next 4 digits and at 354 determine the port number. The mobile device can use various techniques to determine the port number based on the number from 346.

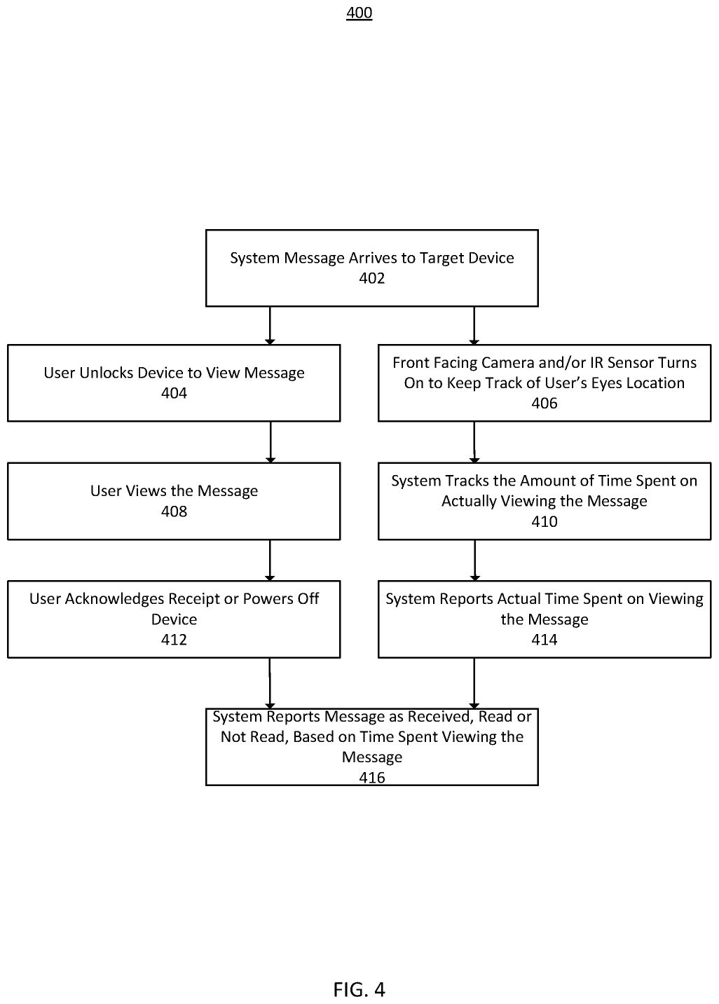

FIG. 4 depicts a flow diagram depicting an example method of message delivery verification through retinal tracking, in accordance with an implementation. The method 400 can be performed by one or more component or functionality of system 100 depicted in FIG. 1, including, for example, a data processing system 102, network 101, gateway device 158 and mobile device 156.

At 402, a system message arrives to a target device (e.g., mobile device). At 404, a user unlocks the device to view the message. At 406, a front facing camera or infrared sensor can turn on to track the user's eye location or eye movement. At 408, the user views the message. While the user views the message, the mobile device can track the amount of time spent on actually viewing the message at 410. The eye movement can be tracked to determine whether the user is actually focusing on the message contents, such as text of the message. At 412, the user can acknowledge receipt or power off the device. At 414, the system can report the actual time the user spent on viewing the message based on the tracked eye movement. At 416, the system can report the message as received, read, or not read based on the amount of time the user spent viewing the message based on the eye movement tracking.

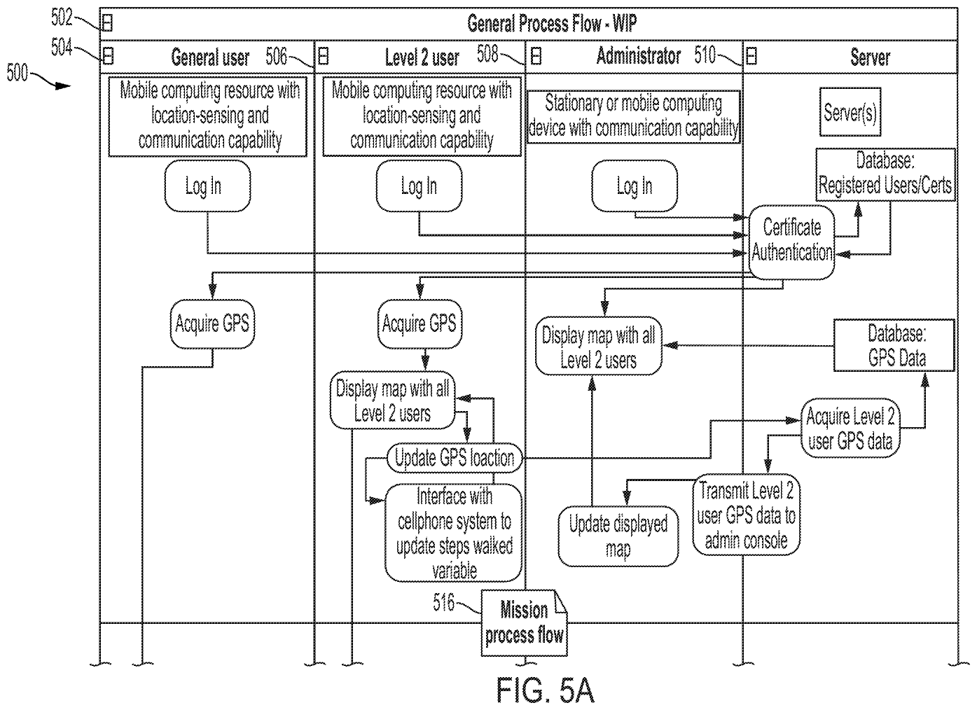

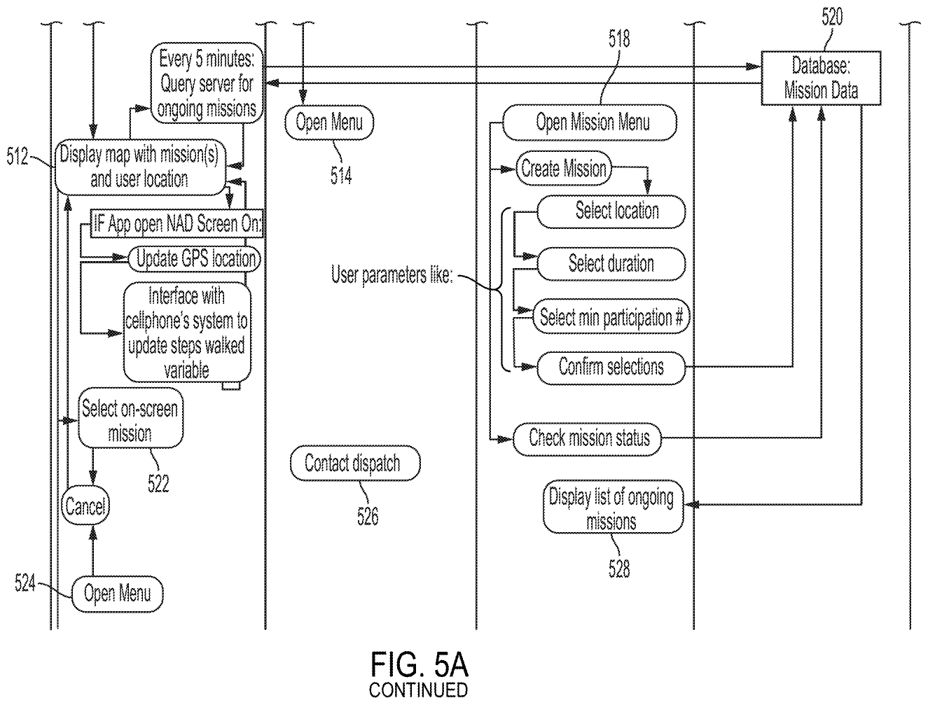

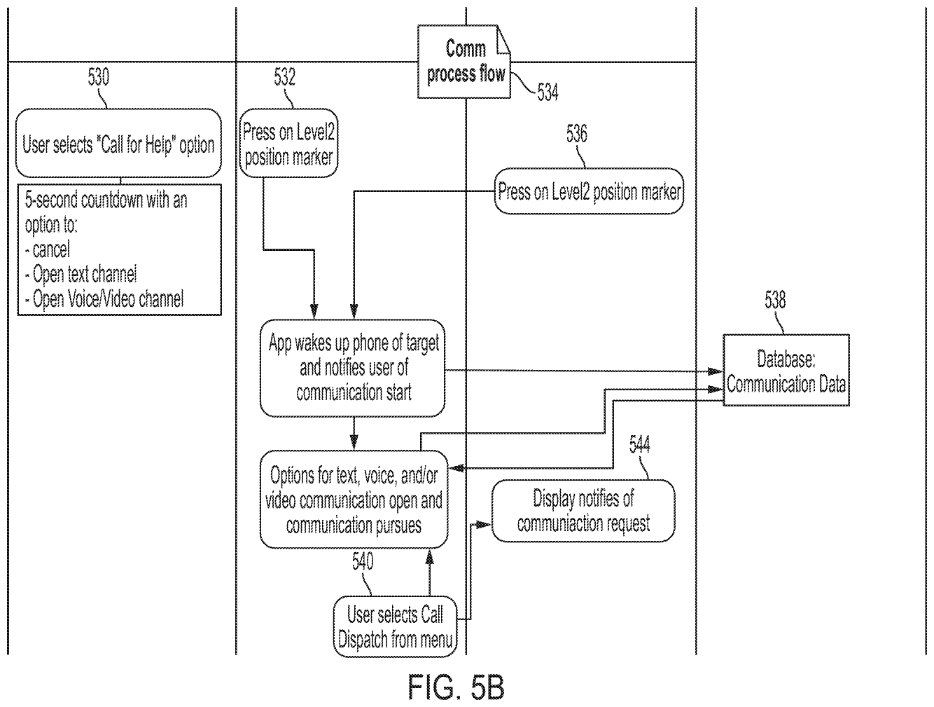

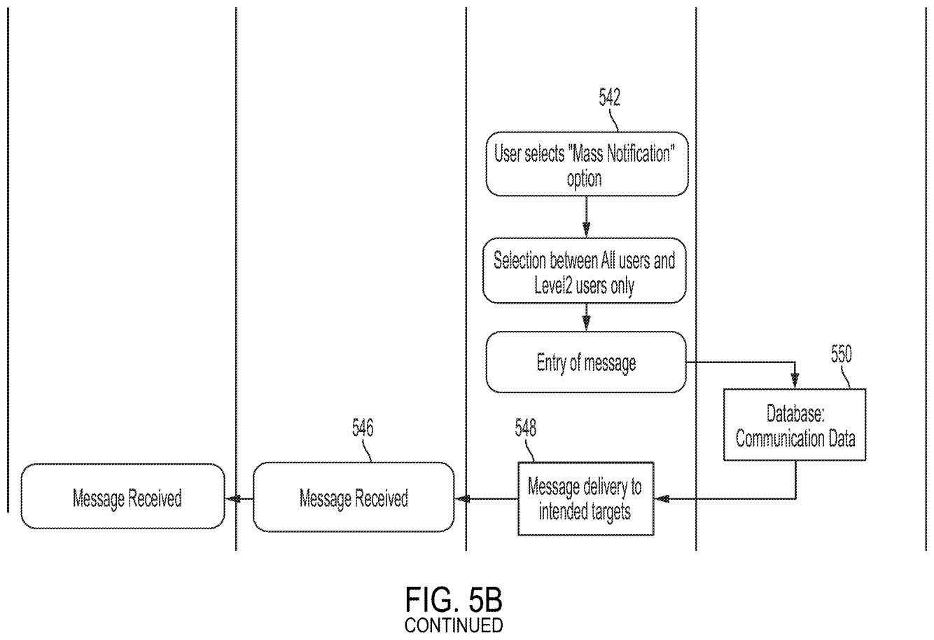

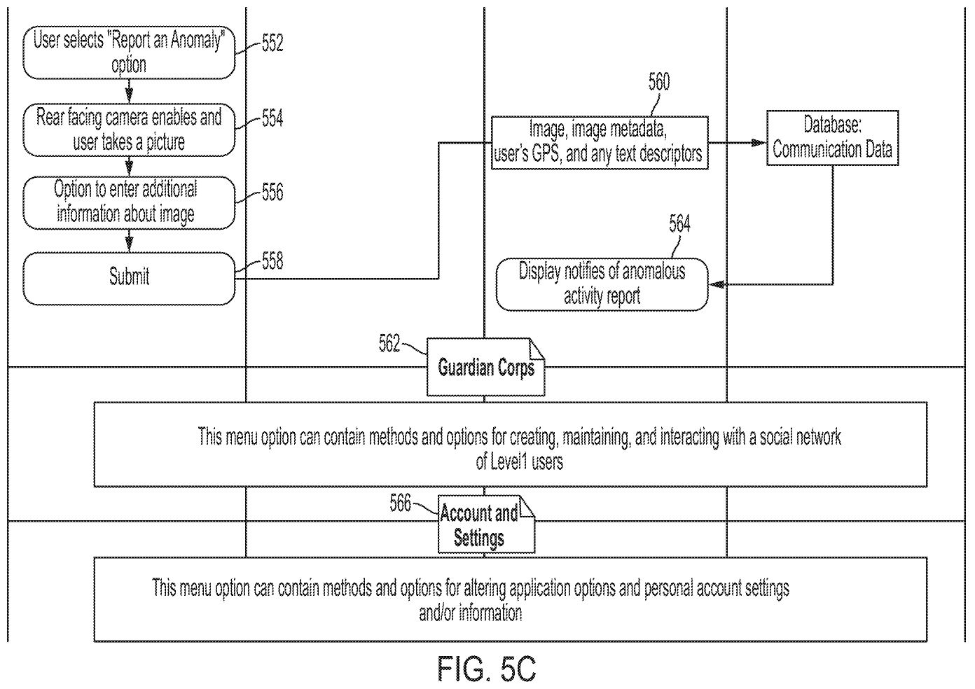

FIGS. 5A-5C depict a flow diagram depicting an example method of distributed sensing through mobile devices, in accordance with an implementation. The method 500 can be performed by one or more component or functionality of system 100 depicted in FIG. 1, including, for example, a data processing system 102, network 101, gateway device 158 and mobile device 156. The ACTS 502-566 depict methods of distributed sensing through mobile devices.

For example, at ACT 530, if cancel not selected, two nearest Level2 users are notified of help request; administrator notified of help request; the default communication channel between all relevant parties can be txt with Level1 user's option to go video and/or voice; one or more device video cameras can turn on and broadcast to the two Level2 users and the Administrator; user's GPS and/or other location sensors actively on, broadcasting location to the two Level2 users and the Administrator; in selecting two nearest Level2 users, the system can select from two who are most likely to be able to arrive on the scene in a timely manner, based on factors like proximity, whether they are/are not in a vehicle, and whether they are being otherwise engaged. Communication received by the Administrator can be stored on the Server(s) or transcribed (in case of voice data). The Administrator can also have the ability to assign additional or alternate Level2 user(s) at any time of the “Call for Help” response.

The system can use block chain mechanics, potentially but not necessarily coupled with digital certificates either issued by or stored on a computing device or resource, to achieve precise system-time synchronization across all relevant terminals. That time synchronization can then be used for “port-hopping”, changing the communication ports of the electronic system(s) across the entire relevant system infrastructure in a pattern based on the block chain contents, and possibly their relation to an issued certificate.

The system can use a verification method to determine receipt of mass notifications. Upon receipt of the message (and opening the app to view) user's front-facing camera and/or IR sensor(s) can enable and commerce to monitor user's eyes' positions as well as the duration of the time eyes were focused on the message. If not enough time engaged was determine, the message may not be count as “read”

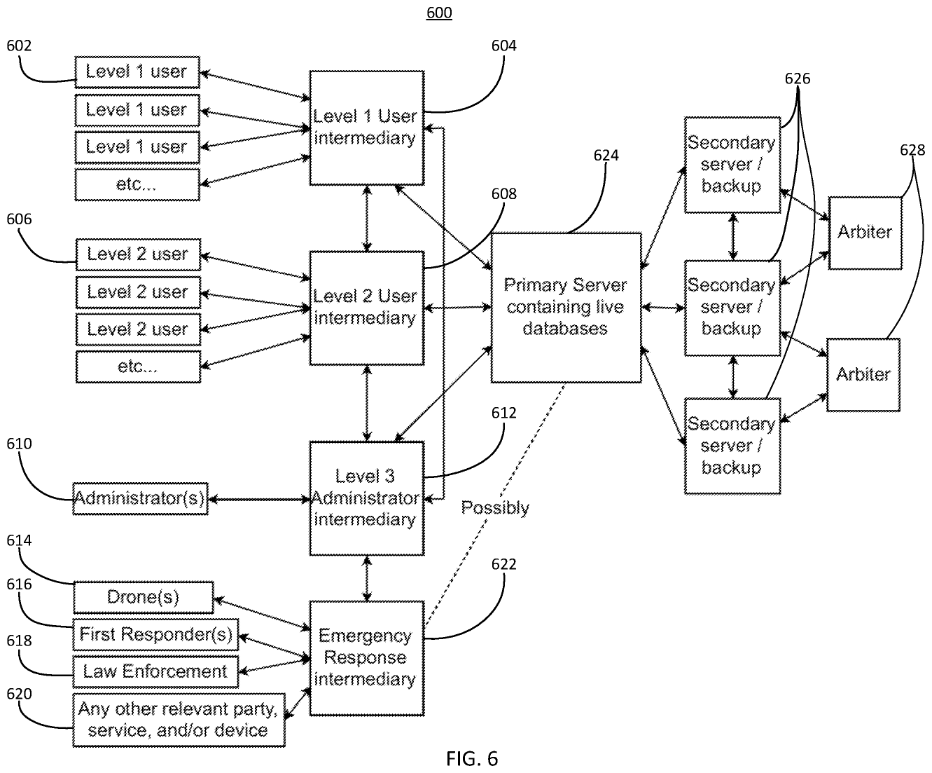

FIG. 6 depicts an operational system diagram depicting an example operation of distributed sensing through mobile devices, in accordance with an implementation. The system 600, or operations thereof, can include or be performed by one or more component or functionality of system 100 depicted in FIG. 1, including, for example, a data processing system 102, network 101, gateway device 158 and mobile device 156. There can be various edge devices (or mobile devices, or third-party devices) with different categorizations, such as level 1 users 602, level 2 users 606, administrators 610, drones 614, first responders 616, law enforcement 618 or other relevant devices 620. Each level can have a corresponding intermediary device, such as 604, 608, 612 and 622 that each communicate with a server 624 (e.g., data processing system 102) and one or more backup servers 626 and arbiters 628.

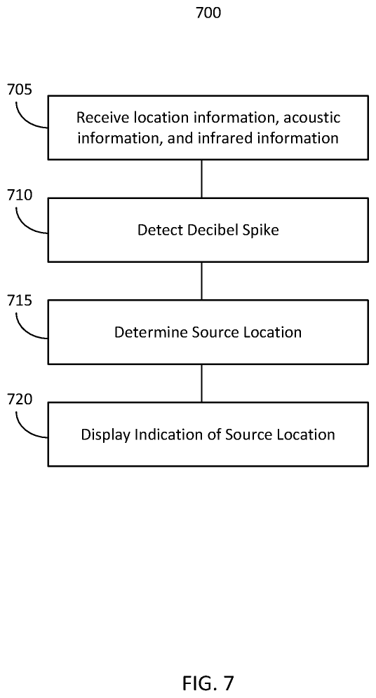

FIG. 7 depicts a flow diagram depicting an example method of distributed sensing through mobile devices, in accordance with an implementation. The method 700 can be performed by one or more component or functionality of system 100 depicted in FIG. 1, including, for example, a data processing system 102, network 101, gateway device 158 and mobile device 156. At 705, a data processing system can receive location information, acoustic information, and infrared information. For example, the data processing system can receive, from a first mobile device of a plurality of mobile devices, first location information, first acoustic information detected by a microphone of the first mobile device, and first infrared information. The data processing system can receive, from a second mobile device of the plurality of mobile devices, second location information, second acoustic information detected by a microphone of the second mobile device, and second infrared information.

At 710, the data processing system can detect a decibel spike. For example, the data processing system can detect, based on a comparison of the first acoustic information with a threshold, a first decibel spike in the first acoustic information corresponding to an event. The data processing system can detect, based on a comparison of the second acoustic information with the threshold, a second decibel spike in the second acoustic information corresponding to the event.

At 715, the data processing system can determine a source location for the event. For example, the data processing system can identify, responsive to detection of the first decibel spike and the second decibel spike, a variance between the first decibel spike and the second decibel spike. The data processing system can determine a source location for the event based on the variance between the first decibel spike and the second decibel spike and at least one of the first infrared information and the second infrared information.

At 720, the data processing system can display an indication of the source location. The data processing system can display, on a display device, an indication of the source location on a map of a building or physical structure.

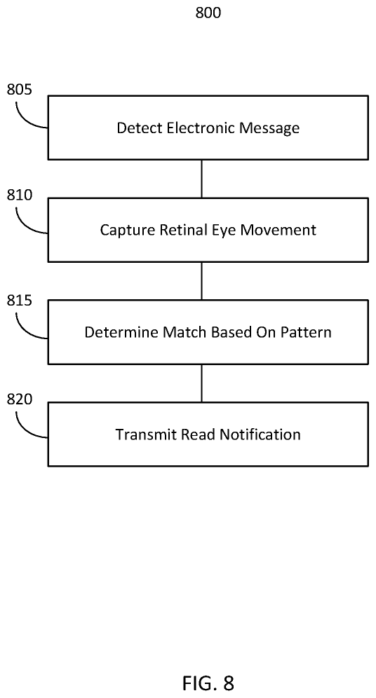

FIG. 8 depicts a flow diagram depicting an example method of message delivery verification through retinal tracking, in accordance with an implementation. The method 800 can be performed by one or more component or functionality of system 100 depicted in FIG. 1, including, for example, a data processing system 102, network 101, gateway device 158 and mobile device 156. At 805, a recipient computing device can detect an electronic message. A sender computing device can transmit the electronic message to the recipient computing device via a network. The electronic message can include a security flag that indicates a security level of confidence level. Confidence levels can include, for example, “for your eyes only” or other indication that the message is confidential or intended to only be viewed or accessed by an authorized user of the recipient computing device or account identifier. The recipient computing device can detect the security flag.

At 810, the recipient computing device can capture retinal eye movement. The recipient computing device can capture, responsive to detection of the security flag, retinal eye movement tracked by a camera of the recipient computing device during display of the electronic message.

The recipient computing device can receive, obtain, or otherwise identify a retinal eye movement pattern corresponding to an account identifier associated with the recipient computing device. The pattern can be stored in memory or other data storage of the recipient computing device, or retrieved from a server or data processing system. The recipient computing device can request the pattern from the data processing system. For example, the recipient computing device can query the data processing system for the pattern.

At 815, the recipient computing device can determine a match based on the pattern. The recipient computing device can determine, based on a comparison of the tracked retinal eye movement with the retinal eye movement pattern, a match.

At 820, the recipient computing device can transmit a read notification. The recipient computing device can transmit, responsive to the match, a read notification to the sender computing device.

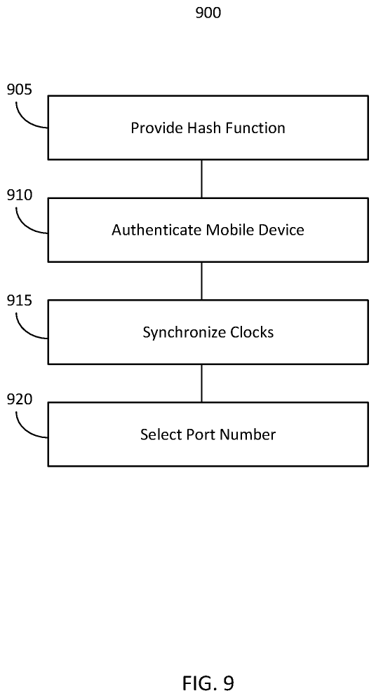

FIG. 9 depicts a flow diagram depicting an example method of active cyber defense through time-based port hopping, in accordance with an implementation. The method 900 can be performed by one or more component or functionality of system 100 depicted in FIG. 1, including, for example, a data processing system 102, network 101, gateway device 158 and mobile device 156. At 905, a data processing system can provide a hash function. The data processing system can provide the hash function and a routing table for storage in a block chain record. The data processing system can provide additional information, such as a code, random number or prime number for storage at the block chain record.

At 910, a gateway device can authenticate a mobile device. The gateway device can provide an indication of the block chain record to the authenticated mobile device.

At 915, the gateway device can synchronize the clock of the authenticated mobile device. For example, the gateway device can provide a timestamp generated by a master clock to cause the client clock of the mobile device to synchronize with the master clock.

At 920, the mobile device can select a port number. The mobile device can determine the port number based on application of the hash function to a current timestamp generated via the client clock of the first mobile device synchronized with the gateway device. The mobile device can switch, change or hop ports based on a time interval during communication with one or more mobile devices connected to the gateway device.

Port hopping can hide a service identify and confuse attackers during reconnaissance by constantly altering service ports. A port can refer to an endpoint of communication. Physical as well as wireless connections are terminated at ports of hardware devices. At the software level, within an operating system, a port can be a logical construct that identifies a specific process or a type of network service. Port can be identified for each protocol and address combination by 16-bit unsigned numbers, referred to as the port number. Inbound packets are received, and the port number in the header can be used to decide which application is to be passed the packets.

The port number can be a 16-bit unsigned integer ranging from 0 to 65535. For TCP, port number 0 is reserved and cannot be used, while for UDP, the source port is optional and a value of zero means no port. A process can associate its input or output channels via an Internet socket, which is a type of file descriptor, with a transport protocol, an IP address, and a port number. This is known as binding, and enables the process to send and receive data via the network. The operating system's networking software has the task of transmitting outgoing data from all application ports onto the network, and forwarding arriving network packets to processes by matching the packet's IP address and port number. For TCP, only one process may bind to a specific IP address and port combination. By performing time-based port hoping, the system can switch a port for an application, service, or function, such as a client application executing on the mobile device.

FIG. 10 is a block diagram of an example computer system 1000. The computer system or computing device 1000 can include or be used to implement the data processing system 102, or its components such as the data processing system 102. The computing system 1000 includes at least one bus 1005 or other communication component for communicating information and at least one processor 1010 or processing circuit coupled to the bus 1005 for processing information. The computing system 1000 can also include one or more processors 1010 or processing circuits coupled to the bus for processing information. The computing system 1000 also includes at least one main memory 1015, such as a random access memory (RAM) or other dynamic storage device, coupled to the bus 1005 for storing information, and instructions to be executed by the processor 1010. The main memory 1015 can be or include the memory 112. The main memory 1015 can also be used for storing position information, vehicle information, command instructions, vehicle status information, environmental information within or external to the vehicle, road status or road condition information, or other information during execution of instructions by the processor 1010. The computing system 1000 may further include at least one read only memory (ROM) 1020 or other static storage device coupled to the bus 1005 for storing static information and instructions for the processor 1010. A storage device 1025, such as a solid state device, magnetic disk or optical disk, can be coupled to the bus 1005 to persistently store information and instructions. The storage device 1025 can include or be part of the memory 112.

The computing system 1000 may be coupled via the bus 1005 to a display 1035, such as a liquid crystal display, or active matrix display, for displaying information to a user such as a driver of the vehicle 126 or the second vehicle 102. An input device 1030, such as a keyboard or voice interface may be coupled to the bus 1005 for communicating information and commands to the processor 1010. The input device 1030 can include a touch screen display 1035. The input device 1030 can also include a cursor control, such as a mouse, a trackball, or cursor direction keys, for communicating direction information and command selections to the processor 1010 and for controlling cursor movement on the display 1035. The display 1035 can be part of the data processing system 102, mobile device 156, or other component of FIG. 1, for example.

The processes, systems and methods described herein can be implemented by the computing system 1000 in response to the processor 1010 executing an arrangement of instructions contained in main memory 1015. Such instructions can be read into main memory 1015 from another computer-readable medium, such as the storage device 1025. Execution of the arrangement of instructions contained in main memory 1015 causes the computing system 1000 to perform the illustrative processes described herein. One or more processors in a multi-processing arrangement may also be employed to execute the instructions contained in main memory 1015. Hard-wired circuitry can be used in place of or in combination with software instructions together with the systems and methods described herein. Systems and methods described herein are not limited to any specific combination of hardware circuitry and software.

Although an example computing system has been described in FIG. 10, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., event detection component 108), and the comparator 110, event locator 112 and command generator 114 illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only as well as both ‘A’ and Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

1. A system for active network security in information technology infrastructure, comprising:
a data processing system, comprising one or more processors, to provide a hash function and a routing table for storage in a block chain record;
a gateway device comprising one or more processors to:
authenticate a first mobile device;
provide, responsive to authentication of the first mobile device, an indication of the block chain record to the first mobile device; and
provide, to the first mobile device, a timestamp generated by a master clock to cause a client clock of the first mobile device to synchronize with the master clock; and
the first mobile device to determine a port number based on application of the hash function to a current timestamp generated via the client clock of the first mobile device synchronized with the gateway device, wherein the first mobile device hops ports based on a time interval during communication with one or more mobile devices connected to the gateway device.

2. The system of claim 1, wherein the master clock of the gateway device corresponds to a global positioning system clock.

3. The system of claim 1, comprising:
the first mobile device to retrieve, from the block chain record, the hash function.

4. The system of claim 1, comprising the first mobile device to:
detect that the gateway device entered an offline mode;
synchronize, responsive to the detection, the client clock with a remote master clock different from the master clock of the gateway device;
establish a mesh network with the one or more mobile device based on application of the hash function to a timestamp generated by the client clock synchronized with the remote master clock; and
communicate, via the mesh network absent the gateway device, with the one or more mobile devices, wherein the first mobile device and the one or more mobile devices hop ports based on the time interval during communication with one or more mobile devices connected to the gateway device.

5. The system of claim 1, comprising the gateway device to:
receive, from the first mobile device, a data packet configured for transmission to a second gateway device;
determine, based on the routing table, an IP address for the second gateway device; and
forward, to the second gateway device, the data packet.

6. The system of claim 5, wherein the gateway device forwards the data packet to the second gateway device via an anonymous overlay network comprising a plurality of relays.

7. The system of claim 1, comprising the gateway device to:
determine a network latency based on the authentication process executed with the first mobile device;
transmit, to the first mobile device responsive to authentication of the first mobile device, a data packet comprising a first timestamp generated by the data processing system and the network latency determined based on the authentication process executed with the first mobile device;
receive, from the first mobile device, a second timestamp generated by the first mobile device based on the first timestamp and the network latency; and
synchronize, based on the second timestamp received from the first mobile device and a ping time, the first mobile device.

8. The system of claim 1, comprising the data processing system to:
determine a network latency based on the authentication process executed with the first mobile device;
transmit, to the first mobile device responsive to authentication of the first mobile device, a data packet comprising a first timestamp generated by the data processing system and the network latency determined based on the authentication process executed with the first mobile device;
receive, from the first mobile device, a second timestamp generated by the first mobile device based on the first timestamp and the network latency;
ping the first mobile device to determine a ping time;
determine a difference between a current time of the clock of the data processing system and half the ping time; and
determine that the first mobile device is synchronized with the data processing system based on the second timestamp matching the difference.

9. The system of claim 1, comprising the data processing system to:
store an updated hash function at a subsequent block chain record; and
provide, to the gateway device, an indication of the subsequent block chain record.

10. The system of claim 1, comprising the first mobile device to:
determine a hash value based on the hash function and the current timestamp; and
select the port number as the hash value.

11. The system of claim 1, comprising the first mobile device to:
determine a message authentication code based on a message authentication process;
select the port number based on inputting the message authentication code into the hash function.

12. The system of claim 1, comprising the first mobile device to:
determine a hash value based on the hash function and the current timestamp;
identify a first digit in the hash value based on the prime number;
identify a predetermined number of digits in the hash value adjacent to the first digit; and
select the port number based on a combination of the first digit and the predetermined number of digits.

13. The system of claim 1, comprising the data processing system to:
synchronize a clock of the second mobile device with the clock of the data processing system; and
provide, to the second mobile device, the hash function and the prime number to cause the second mobile device to select the same port number selected by the first mobile device to establish a communication between the first mobile device and the second mobile device.

14. A method for active network security in information technology infrastructure, comprising:
providing, by a data processing system comprising one or more processors, a hash function and a routing table for storage in a block chain record;
authenticating, by a gateway device comprising one or more processors, a first mobile device;
providing, by the gateway device responsive to authentication of the first mobile device, an indication of the block chain record to the first mobile device;
providing, by the gateway device to the first mobile device, a timestamp generated by a master clock to cause a client clock of the first mobile device to synchronize with the master clock;
determining, by the first mobile device, a port number based on application of the hash function to a current timestamp generated via the client clock of the first mobile device synchronized with the gateway device, wherein the first mobile device hops ports based on a time interval during communication with one or more mobile devices connected to the gateway device.

15. The method of claim 14, wherein the master clock of the gateway device corresponds to a global positioning system clock.

16. The method of claim 14, comprising:
retrieving, by the first mobile device, the hash function from the block chain record.

17. The method of claim 14, comprising:
detecting, by the first mobile device, that the gateway device entered an offline mode;
synchronizing, by the first mobile device responsive to the detection, the client clock with a remote master clock different from the master clock of the gateway device;
establishing, by the first mobile device, a mesh network with the one or more mobile devices based on application of the hash function to a timestamp generated by the client clock synchronized with the remote master clock; and
communicating, by the first mobile device, via the mesh network absent the gateway device, with the one or more mobile devices, wherein the first mobile device and the one or more mobile devices hop ports based on the time interval during communication with one or more mobile devices connected to the gateway device.

18. The method of claim 14, comprising:
receiving, by the gateway device from the first mobile device, a data packet configured for transmission to a second gateway device;
determining, by the gateway device based on the routing table, an IP address for the second gateway device; and
forwarding, by the gateway device to the second gateway device, the data packet.

19. The method of claim 18, wherein the gateway device forwards the data packet to the second gateway device via an anonymous overlay network comprising a plurality of relays.

20. The method of claim 14, comprising:
determining a network latency based on the authentication process executed with the first mobile device;
transmitting, to the first mobile device responsive to authentication of the first mobile device, a data packet comprising a first timestamp generated by the data processing system and the network latency determined based on the authentication process executed with the first mobile device;
receiving, from the first mobile device, a second timestamp generated by the first mobile device based on the first timestamp and the network latency; and
synchronizing, based on the second timestamp received from the first mobile device and a ping time, the first mobile device.

21-60. (canceled)
